(19) United States
(12) Patent Application Publication
(10) Pub. No.: US 2015/0154361 A1
(43) Pub. Date: Jun. 4, 2015

(54) INTERACTIVE WHITEBOARD SYSTEM AND METHOD

(71) Applicants: THE CLEVELAND CLINIC FOUNDATION, Cleveland, OH (US); iVHR, Inc., Cleveland, OH (US)

(72) Inventors: Wael K. Barsoum, Bay Village, OH (US); Douglas R. Johnston, Shaker Hts., OH (US); Wisam Rizk, Westlake, OH (US); Michael W. Kattan, Cleveland, OH (US); Devin L. Gaymon, Solon, OH (US); William H. Morris, Shaker Hts., OH (US)

(21) Appl. No.: 14/573,760

(22) Filed: Dec. 17, 2014

Related U.S. Application Data
(63) Continuation-in-part of application No. 13/469,281, filed on May 11, 2012.
(60) Provisional application No. 61/917,144, filed on Dec. 17, 2013.
(60) Provisional application No. 61/484,902, filed on May 11, 2011.

(51) Int. Cl. G06F 19/00

(52) U.S. Cl. CPC G06F 19/322; G06F 19/3437; G06F 19/321; G06F 19/345

(57) ABSTRACT

This disclosure relates to a visualization tool that can be implemented to facilitate medical decision making by providing an interactive whiteboard of relevant health data. The interactive whiteboard can include interactive graphical elements representing health data objects and relationships among objects that can be manipulated or modified in response to graphical user interface controls.

### CROSS-REFERENCE TO RELATED APPLICATIONS

This application claims the benefit of U.S. Provisional Patent Application 61/917,144 filed on Dec. 17, 2013, and entitled WHITEBOARD SYSTEM AND METHOD. This application is also a continuation-in-part of U.S. patent application Ser. No. 13/469,281 filed on May 11, 2012, and entitled INTERACTIVE VISUALIZATION FOR HEALTHCARE, which claims the benefit of U.S. Provisional Patent Application No. 61/484,902, filed May 11, 2011, and entitled DIAGNOSTIC MAPPING. Each of the above-identified applications is incorporated herein by reference in its entirety.

### TECHNICAL FIELD

This disclosure relates to whiteboard systems and related methods.

### BACKGROUND

Visualization of relationships and associations among related data can help drive a variety of services for different industries. In the healthcare industry, for example, electronic medical records (EMRs) are used to facilitate storage, retrieval and modification of management of health care information records. The EMR is used to document aspects of patient care and billing for healthcare services, typically resulting in voluminous data is stored and accessed for patients. The user interfaces for EMR systems tend to be quite rigid. For example, the user interfaces are often modeled similar to the paper charts that they were intended to replace. Additionally, use of such EMR systems can be oftentimes frustrating to healthcare providers due to the voluminous amounts of data stored in an EMR database.

### SUMMARY

This disclosure relates to a whiteboard system and related method.

As one example, a computer implemented method may include representing selected health data objects, corresponding to at least one health problem and supporting evidence, as graphical nodes in an interactive workspace. Each of the health data objects may include metadata that includes an identifier and status data stored in memory to describe at least one condition of the respective health problem or supporting evidence being represented thereby. The method may also include representing relationships between the supporting evidence and related health problems in the interactive workspace based on relationship data stored in the memory. Graphical user interface controls may be employed for implementing each of a plurality different user interactions with respect to the graphical nodes and associated relationships visualized in the interactive workspace. One or more of the metadata and relationship data in the memory may be updated in response to a user interaction changing at least one of the relationships between a pair of graphical nodes representing health data objects in the interactive workspace.

As another example, a system can include a patient white board system that includes data representing selected data objects as graphical nodes and representing links between the selected health data objects as graphical connections between related graphical elements based on relationship data stored in memory for a given patient encounter. Graphical user interface controls may implement interactions with respect to the graphical nodes and relationships. A diagnosis calculator can be programmed to compute a list of potential diagnoses based on analyzing the guideline data relative to the evidence data objects for the given patient encounter.

### BRIEF DESCRIPTION OF THE DRAWINGS

FIG. 1 depicts an example block diagram of a system for implementing a whiteboard system.

FIG. 2 depicts and example of whiteboard data that can be generated for one or more patients.

FIGS. 3-9 depict examples of an interactive whiteboard workspace that can be implemented.

FIGS. 10-15 depict examples of an interactive whiteboard workspace and associated logic flow that can be implemented for creating a heart valve replacement node.

FIGS. 16-17 depict additional examples of a whiteboard workspace that can be implemented for filtering data objects.

FIG. 18 depicts examples of a whiteboard workspace that can be implemented for presenting actionable to-do items.

FIGS. 19-22 depict examples of a whiteboard workspace showing a matrix view of data objects.

### DETAILED DESCRIPTION

This disclosure relates to health care and more particularly to an interactive visualization of healthcare information.

As an example, the systems and methods provide a patient care whiteboard interface to visually represent the relationships and the relationship statuses between important medical data related to a patient diagnosis. For instance, the medical data can be represented as units of health data objects, such as problems, procedures, medications, studies, clinical data (e.g., labs or tests), and the like. The systems and methods store local workspace data to define respective health data objects as well as the relationships among health data objects and a status of such relationships. The systems and methods can generate a dynamic interactive workspace that visually represents (e.g., graphically) relationships between problems and supporting evidence. As used herein, the supporting evidence can include studies, medications, procedures, clinical data as well as other problems. In some examples, each of the health data objects can be graphically represented in the interactive workspace as corresponding nodes with relationships between nodes graphically represented as connector lines based on relationships metadata. The interactive workspace thus can provide an interactive, graphical problem-oriented record for a given patient representing health data objects (e.g., derived from EHR data and associated workspace data). For example, the interactive workspace enables physicians and other healthcare providers to interpret the clinical data quickly and effectively and to identify patients with high acuity levels. As a result, the interactive workspace provides a context-specific whiteboard for healthcare providers to collect, display, navigate and analyze complex healthcare data easily and intuitively.

The systems and methods disclosed herein further can automate the documentation process for patient management and care by automatically compiling data that is visually represented on the interactive workspace, merge such data with patient and provider data (e.g., from an EHR system) and dynamically generate a clinical a text document (e.g., a note) for a given patient encounter. The generated document can be submitted to the EHR system to be stored in the patient's record via an EHR interface. Due to the intuitive nature of the graphical workspace with which the user interacts the process of documenting care and patient management can be facilitated and should help improve diagnostic accuracy.

The systems and methods further may employ a guidelines engine to recommend the relationships between health care data objects, corresponding to problems and supportive evidence. For example, the guidelines engine can recommend to add and draw the connector lines or otherwise graphically represent relationships between the problem nodes and supporting evidence nodes (e.g., medications, clinical, studies, procedures, and the like) based upon the documented, preprogrammed clinical guidelines (e.g., accepted best practices for a given healthcare enterprise or national standards).

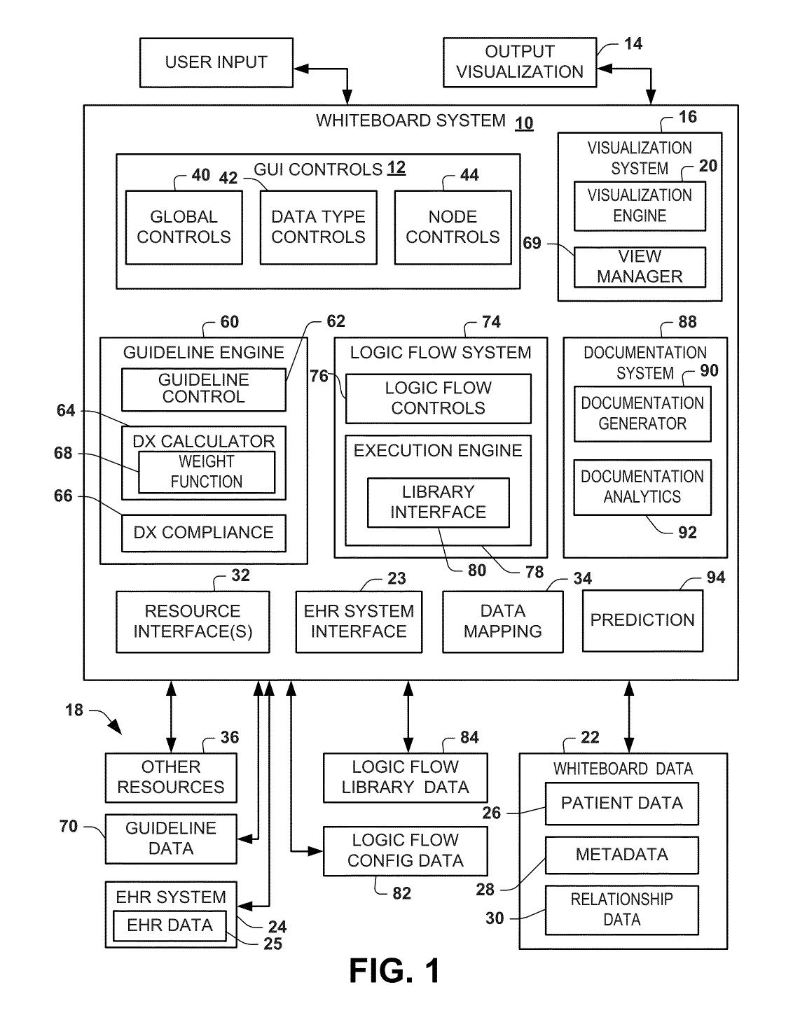

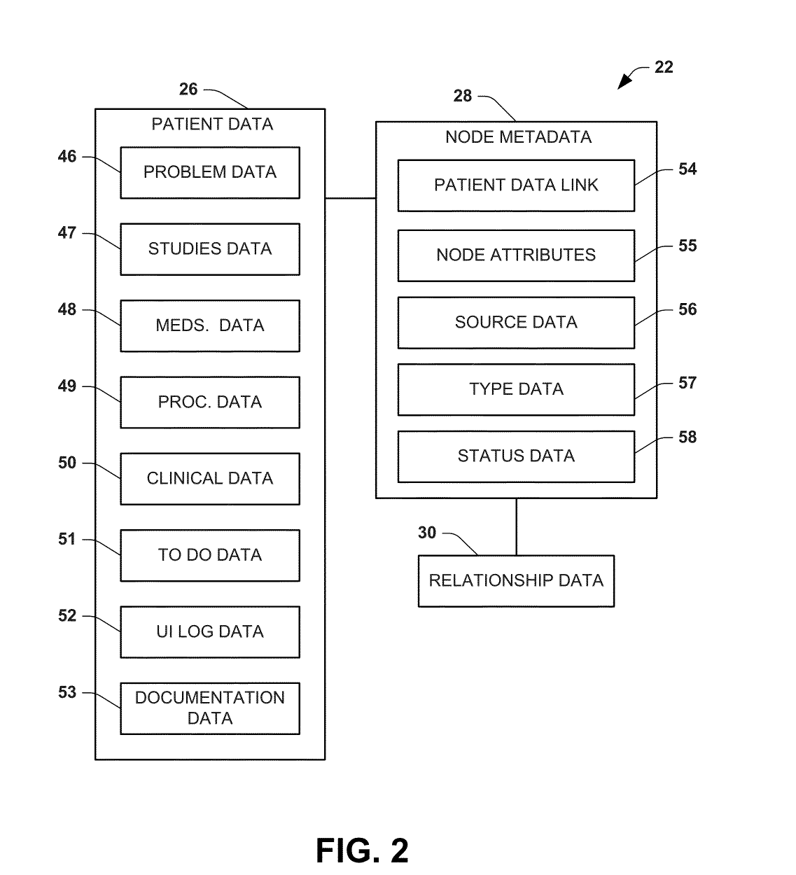

FIG. 1 depicts an example of a whiteboard system 10 that can be implemented according to an embodiment. The whiteboard system 10 and its various components can be implemented to include data and computer readable instructions, which when executed by a processor, perform one or more methods as disclosed herein. The whiteboard system 10 includes graphical user interface (GUI) controls 12 programmed to control user interactions with an interactive output visualization 14 (e.g., via a user input device, such as a mouse, touchpad, touchscreen or the like). The interactive output visualization 14 can include an arrangement of nodes, corresponding to health data objects. As disclosed herein (see, e.g., FIG. 2), each of the nodes can represent a health data object for a given patient, such as including problem data, medication data, clinical data (e.g., labs or other test results), studies data, procedures data, and the like. In addition to the interactive output visualization 14 displaying nodes corresponding to a set of health data objects for the given patient, relationships and associations between and among such data objects are graphically represented in the interactive workspace. Each of the relationships as well as the nodes are interactive graphical user interface elements that can be modified by the GUI controls 12 in response to a user input. Each modification of a relationship or node may result in a corresponding change to metadata that is stored in memory associated with the underlying health data objects.

The GUI controls 12 can also provide access to functions and methods (e.g., tools) that operate on the underlying data objects and respective associations and/or control various aspects of the visualization 14 in response to user inputs implemented relative to the workspace provided in the output visualization 14. The system 10 includes a visualization system 16 programmed to control the output visualization 14 in response to instructions provided via the GUI controls 12 and based on information, generally indicated at 18, which is utilized by the whiteboard system 10. For example, the information 18 utilized to generate the output visualization can include data retrieved from and/or be derived from various sources of data 22, 24, 25, 36 and 70, such as disclosed herein.

The system 10 and resulting output visualization 14 can relate to various types of information, such as associated with provision of a service to a customer, the customer itself, the service provider or a combination thereof. In the following examples, the system 10 and the visualization is described in the context of an interactive whiteboard related to healthcare information, such as for a given patient, although the system is not limited to healthcare. In the following examples, the healthcare information can include diagnostic-related information for one or more patient's (human or otherwise), administration information for a facility, practice or institution as well as any other information that can be useful in providing care or managing the provision of care to one or more patients.

By way of example, the visualization system 16 includes a visualization engine 20 programmed to generate the output visualization 14 to include an interactive graphical whiteboard, representing selected health data objects as graphical nodes and relationships between corresponding health data objects in the graphical output visualization 14. In some examples, the relationships between each problem node and supporting evidence nodes can be represented as lines connected between such nodes based on relationship metadata stored in the whiteboard data 22. In other examples, relationships can be graphically represented by displaying supporting nodes within a common row of a matrix (e.g., a grid) with the problem node it supports or simply by clustering supporting nodes within a predetermined proximity of a problem node.

The visualization engine 20 can generate the graphical interactive workspace based on the local whiteboard data 22. The whiteboard data 22 can include patient data 26, metadata 28 and relationship data 30. The patient data 26 can include data acquired from one or more other separate resources, such as from the EHR system 24 data repository 24 or other resources 27. For example, the system 10 can includes and EHR system interface 23 that is programmed to access the EHR data 25 of an associated EHR system 24 to retrieve a selected set of EHR data (e.g., health data objects) for one or more patient's. Additionally or alternatively the system 10 can includes and one or more other interfaces 32 programmed to access each of the other resources 36.

For example, the repository interface 23 can be programmed to pull (e.g., retrieve) the EHR data 24 in response to instructions specifying one or more patient's by patient ID or other identifying information. Additionally, in some example, the interface 23 can include methods and functions programmed to push selected patient data 26 back to the data repository 24 in response to instructions from the system 10, such as in examples where the whiteboard system 10 is fully integrated with the EHR system 24. It is to be understood and appreciated that in a given network or enterprise the EHR system 24 can correspond to one or more different types of EHR systems that may be implemented in different locations or for different portions of the given network or enterprise. Accordingly, the interface 23 can be extensible and appropriately programmed to selectively push and pull data for each such EHR system that may be utilized to store and manage patient records for a respective healthcare enterprise.

The whiteboard system 10 can also include a data mapping module 34 to transfer the retrieved data from external sources, such as EHR system 24 or other resources 36, into a corresponding locations of a data structure (e.g., table) of patient data 26. As mentioned, the health data objects for a given patient can include problems data, studies data, medications data, procedures data and clinical data. For example, the data mapping 34 can map each clinical code and/or billing code as well as units of descriptive text, as stored in the EHR system, into corresponding field of patient data 26. The whiteboard system 10 can determine metadata 28 for the nodes based on the data retrieved from the EHR system 24 and the other sources 36 as well as in response to user inputs via the interactive workspace (e.g., interacting with nodes).

As disclosed herein the whiteboard data 22 includes local data that is separate from the repository (e.g., corresponding to an electronic health record (EHR) data repository) 25. The term local is not intended to imply such data being stored in the same machine within any spatial proximity as the device implementing the whiteboard system, but that the whiteboard data is maintained outside of the EHR system. For instance, the whiteboard data 22 could be stored in memory at one machine or distributed over a network and accessible by the whiteboard system 10 via one or more communications links. The metadata 28 (e.g., data that describes the data objects and data associations) can be extensible to accommodate various types of information, which can vary depending on the data type, patient condition and/or user interaction relative to such node via the system 10. Such metadata 28 can thus be utilized to provide additional information about each respective node, including accessing information details from associated patient data 26. For instance, corresponding metadata can be employed to present information in a textual and/or graphical manner in response to hovering a pointing element over or otherwise selecting a given graphical element or connection. The additional information presented based on the metadata 28 associated with such selected element can be graphically presented in a superimposed manner or adjacent to the selected element, such as a pop-up window or other form of representation.

The relationship data 30 can be derived from the information obtained from the EHR system or other sources and/or be generated in response to a user input creating and defining a relationship between two nodes in the interactive workspace. The relationship data 30 of the metadata may specify the existence and type of supporting relationship from one node to another node. For instance, the relationship data can specify unique identifiers (IDs) for each pair of related nodes as well as status information about the type of relationship and how the relationship was created (e.g., automatically generated from EHR data, confirmed by a given user and/or manually created in response to a user input). The relationship data 30 can also include relevance information for a given relationship, such as disclosed in the above-incorporated U.S. patent application Ser. No. 13/469,281. The graphical presentation of the relationship in the output visualization 14 can vary depending on the relationship data 30.

The visualization system 16 thus employs the node metadata 28 to generate the visualization 14 corresponding to the interactive workspace that includes an arrangement of nodes. Relationships between respective nodes are generated based upon relationship data 30. For example, the relationship data can include unique identifiers for each node pair that has been determined to be related as well as attributes for the relationship, such as can include the source and status of the relationship. For example the source of a relationship can indicate whether the relationship was established in response in to a user input and identify the particular user. In other examples, the relationship can be determined automatically based upon the guideline engine 60 from an analysis of the patient's data 26.

By way of example, FIG. 2 demonstrates an example of a data structure model for the whiteboard data 22, which includes an arrangement of patient data 26, node metadata 28, and relationship data 30. In the example of FIG. 2, the patient data 26 can include problem data 46, study data 47, medications data 48, procedures data 49 and clinical data 50, each of which can correspond to a respective health data object. For example, the problem data 46 can include a record for an identified problem such as a given coded diagnosis as well as status data, such as indicating whether the diagnosis and problem is active or has been resolved. Additional information about the underlying problem, such as can be derived from the EHR data 25, and/or in response to the user input via the whiteboard system 10, can also be stored in the corresponding health data objects 46-50.

In addition to the health data objects 46, 47, 48, 49 and 50, the patient data 26 can also include “to-do” data 51, user input (UI) log data 52 and documentation data 53. The to-do data 51 can include a set (e.g., list) of action items that a given user that is logged into the system needs to perform. For example, the to-do data can include updates needed be made by the user in to the EHR system 24, such as where the whiteboard system 10 is not fully integrated with the EHR system due to the interface 23 operating unidirectionally (e.g., it can retrieve data from the EHR system 24 but cannot write or update the EHR system 24). For instance, the unidirectional interface 23 that can pulls data from the EHR system only may be implemented for a variety of purposes.

The to-do data 51 thus can be updated manually in response to a user input indicating that an item listed has been performed by the user. In other examples, in response to retrieving patient data from the EHR system 24, the whiteboard system 10 can be programmed to compare the retrieved updated data with respect to information contained in the to-do data table 51 to ascertain whether the item has been updated in the EHR system 24. If the EHR system had been updated consistent with the current to-do item, the whiteboard system 10 can detect the update from the patient health data 46-50 and, in turn, remove the item from the to-do list. In contrast, if the whiteboard system 10 determines that the appropriate item has not been updated or appended to the EHR system consistent with the entry in the to-do data 51, the item may remain in the to-do data list until manually removed in response to a user input.

The UI log data 52 can include a set of user interactions with the interactive workspace provided by the output visualization 14. For example, each interaction with a node or a relationship between respective nodes (e.g., including adding, removing or modifying a relationship) can be stored in the UI log data 52. In this way, an audit document can be created (e.g., by a document patient system 88) to provide a corresponding audit trail for patient management and review by a healthcare provider, such as disclosed herein.

The documentation data 53 can include one or more notes or other forms of documentation that can be generated via the whiteboard system 10. The documentation data 53 can be generated, for example, by the documentation generator 90 of FIG. 1 in response to a user input. For example, the documentation data 53 can include a note or other descriptive text string that can be generated, such as disclosed herein.

As mentioned, the node metadata 28 can be utilized to generate the interactive workspace, including graphical nodes and relationships between respective nodes that are visualized in the output visualization 14. The node metadata 28 can include a patient data link 54, such as specifying a resource location (e.g., uniform resource indicator (URI) or uniform resource location (URL)) for the health data object that is represented by the given node. The information in a link for a given node can be can be utilized to access any information contained in the patient data 26, including patient information from health data objects 46-47, outstanding action items for the user from the to-do data 51, and other information in the log data 52 and/or documentation data 53.

The node metadata 28 can also include node attributes 55 that describe characteristics of the node, such as including a unique identifier (e.g., node ID) for each node, the spatial location of the node in the interactive workspace as well as flags such as indicating a condition of the node (e.g., whether it is related to another node or an orphan). The node metadata 28 can also include source data 56 such as to specify the creator (e.g., source) of the graphical node, such as whether it was generated automatically by a guideline engine 60 or manually in response to a user input. The source data 56 can also specify the identity of the user (e.g., a user ID based upon login credentials for the system 10).

The node metadata can also specify a type of the metadata such as by specifying an integer or other descriptor. For example, the type data 57 can identify whether the node represents a problem (based upon problem data 46), a study (based upon studies data 47), a medication (based upon medications data 48), a procedure (based upon procedures data 49) or a lab (based upon clinical data 50). The type of data can be employed by the visualization system 16 to control which icon or other prescribed form of graphical element is utilized in the visualization 14 for each respective node. The node metadata may also include status data 58 to specify a current condition associated with the node. For example, the documentation system 88 can be programmed to update status data 58 in the metadata to indicate that the given user has at least one of accessed or caused at least some of the condition data to be visualized in the interactive workspace. The visualization engine can employ the status data 58 for each respective node to render a review indicator graphical element associated with the given health data object node in the interactive workspace to indicate whether the data associated with the node has been reviewed by the user.

The relationship data 30 can specify unique identifiers (e.g., node ID's as provided in the node attribute data 55) associated with each relationship between nodes (e.g., a node pair). As disclosed herein a given node can be related to one or more other nodes and each such relation can be reflected in the relationship data. In addition to specifying node IDs for a given relationship, the relationship data 30 can also specify attributes for the relationship, such as source information described the creator of the relationship, as well as a value specifying the strength or relevance of the relationship. Thus, attributes specified in relationship data 30 can be utilized by the visualization engine 20 to control the visualization of the relationship such as by varying a length or thickness of a respective connector proportional to the strength of the relationship specified in the attribute data.

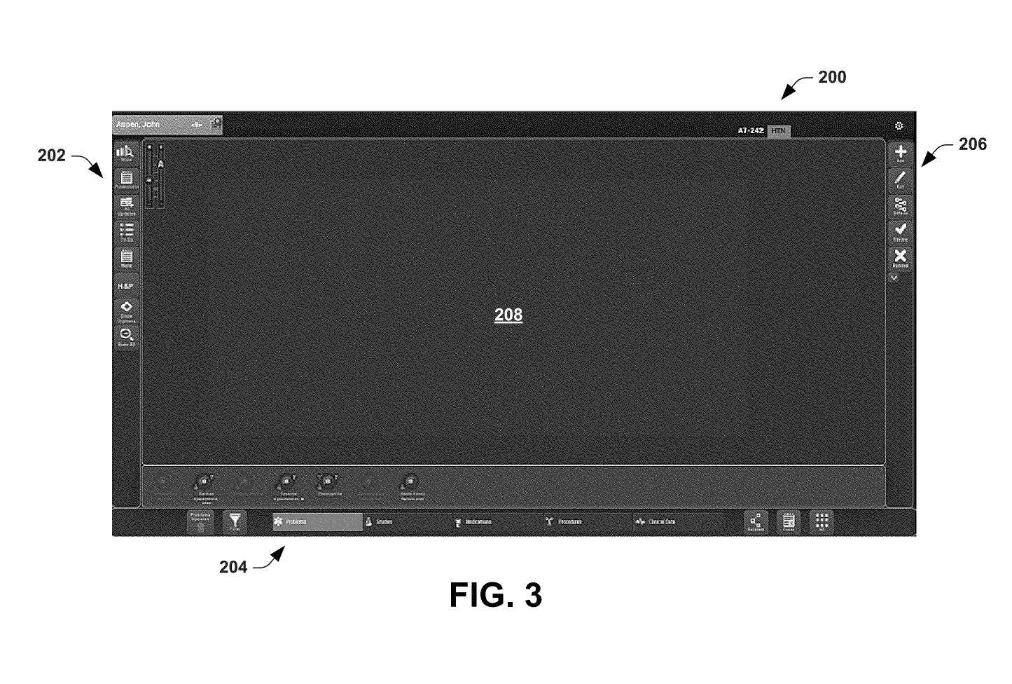

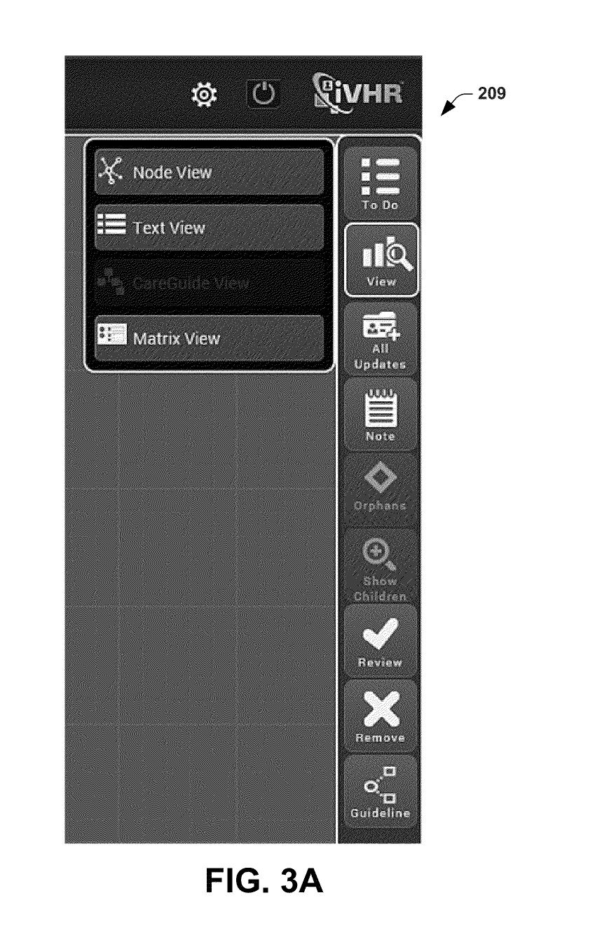

Referring back to FIG. 1, the GUI controls 12 include corresponding controls programmed to provide for various levels of interaction. In the example of FIG. 1, the GUI controls 12 are organized as including global level controls 40, data type level controls 42 and node level controls 44. By way of example and with reference to FIG. 3, an example interactive visualization 200 (e.g., output visualization 14) includes a global controls 204 (e.g., the global controls 40) as part of a programmable toolbar. The controls 204 can be utilized to access user interface features that can include a view control element, a predictions control element, an update control element, a to do control element, a note control element, an H & P (history and physical exam) control element, a show orphans control element and a show/hide all control element. Each of the global controls 40 (FIG. 1) thus relate to functionality can be applied globally with respect to the data objects and associations currently available to the user via the output visualization 14.

The data type level controls 42 of FIG. 1 enable management of the type of data and information that is presented in the interactive workspace for the corresponding patient encounter. The node level controls 44 can be programmed to enable interactions with individual nodes, corresponding to health data objects. The node level controls 44 can be employed to generate new nodes, delete an existing node or to modify attributes of a node. Such functions also results in changes to corresponding metadata 28.

The whiteboard system 10 also includes a guideline engine 60 that is programmed to provide user-guidelines related to healthcare decisions and support based on local whiteboard data 22 and data objects from the data repository 24, which can be provided in response one or more user inputs and/or be provided automatically. In the example of FIG. 1, the guideline engine 60 includes guideline control 62, a diagnosis calculator 64 and a diagnosis compliance function 66. Each of the components 62, 64 and 66 can be configured to provide a level of user guidance based on guideline data 70.

The diagnosis calculator 64 can be programmed to compute diagnosis guidance based on analyzing/correlating health data objects (e.g., nodes) that have been generated for corresponding patient encounter. The diagnosis calculator 64 can compute the diagnosis as including one or more codes (e.g., ICD-9 or ICD-10 codes) based on an analyzing diagnostic guidelines provided by the guideline data 70 relative to node data objects that have been generated for the given patient encounter. For instance, the node data objects can correspond to any of the different health object data types (e.g., Problems, Studies, Medications, Procedures, Clinical Data), which can represent supporting evidence (e.g., Studies, Medications, Procedures, Clinical Data) and/or potential co-morbidities (e.g., other problems).

The diagnosis calculator 64 thus can be programmed to compute a list of potential diagnoses, which may be supported—at least partially—based on the analysis. As a further example, the diagnosis calculator 64 can be programmed to determine and to specify additional evidence, if any, that is needed to support each potential diagnosis in the list that is not fully supported based on the set of available data objects for the given patient encounter and the guideline data 70.

The list of potential diagnoses further can be random or it can be an ordered (e.g., sorted) list. As an example, the list of potential diagnoses can be sorted based a weight value assigned to each respective potential diagnosis. The diagnosis calculator 64 can includes a weight function 68 programmed to assign a weight value to each potential diagnosis. The guideline engine 60 can in turn generate the list of diagnoses by sorting each respective diagnosis in the list of potential diagnoses according to its assigned weight. For example, the weight function 68 can be programmed to determine the weight for each potential diagnosis based on one or a combination of two or more weighting criteria, which can be stored in the guideline data and/or the whiteboard data 22.

By way of example, the weighting criteria can include one or more of diagnostic accuracy (e.g., a computed confidence value) of the potential diagnosis, a specificity of the potential diagnosis, a role of the user, and/or a value of reimbursement for a potential diagnosis. The value of reimbursement can include a rate of reimbursement for a given diagnosis (how often it is accepted or denied by insurance) and/or the monetary value of reimbursement for making a particular reimbursement.

The compliance function 66 can be programmed to analyze a diagnosis, corresponding to a diagnosis code, generated for a given patient encounter in response to a user input relative to guideline data to ascertain if a proposed diagnosis is supported by evidence data objects (e.g., based on patient data 26 and/or node data 28) associated with the current patient encounter. The proposed diagnosis can be one that is generated manually by a user in response to a user input (e.g., via an Add node control element) or one that is generated/suggested to the user automatically (e.g., by the diagnosis calculator 64). The compliance function 66 further can be configured to provide requirements data (in data 22) based determining a difference between the evidence data objects associated with the patient encounter and what is stored as the guideline data 70 for each diagnosis code. The requirements data can be utilized to populate or more new “suggested” nodes in the visualization space to specify one or more items of supporting evidence that would buttress the proposed diagnosis.

For example, each suggested node can be provisionally connected with the proposed diagnosis (as well as any other diagnosis that it might help support) based on the guideline data. The compliance function 66 can be programmed to specify at least one item of evidence (procedure, study, medication, clinical data) needed to support the diagnosis. This can be based on the compliance function 66 analyzing the guideline data 70 for the proposed diagnosis relative and comparing the requirements to the existing node data 28 for the patient encounter. If the requirements are satisfied based on the existing nodes being determined as sufficient to make the proposed diagnosis, an indication can be made that sufficient evidence exists to render the proposed diagnosis. If one or more of the requirements for the proposed diagnosis are not satisfied, the guideline engine 60 can provide a requirements list of supporting evidence (e.g., in the output visualization 14) that is necessary before such diagnosis can be made based on the current guidelines.

As mentioned, each item on the requirements list can be populated into the workspace as a suggested node. A user can review the suggested node (e.g., via the Review node control element) to determine whether to accept the node into the workspace or to reject and remove it from the workspace. In response to accepting the node, an actionable order and/or a ‘to do’ item can be added as a note programmatically associated with the node, such to enable performing a study or procedure or for otherwise acquiring clinical data or prescribing medications.

A suggested graphical connection or suggested node can be implemented in a variety of forms, such as, for example, blinking, animation, dotted lines, different color graphics or other methods to differentiate the suggested link from an actual association that has been validated by a user. In some examples, the suggested health data object can be visualized in a predefined area of the visualization space. The suggested graphical link can remain differentiated from other graphical connections until validated or invalidated by a user. For example, a user can validate a suggested link or diagnosis by clicking on it or otherwise marking it via the GUI controls 12.

A potentially related set of health data objects can comprise two or more health data objects for diagnostic concepts, health data objects for lab data, health data objects for interventions or other supporting evidence that may be entered into the system via the GUI controls 12 or obtained from the data repository 24 or another source (e.g., medical devices, monitoring equipment or the like) for a given patient. The guideline engine 60 can represent the relationship between two or more such potentially related health data objects as a graphical connection between such respective graphical elements for objects according to metadata that is stored as part of the local data 24.

In circumstances where supporting evidence may be sufficient to support a proposed diagnosis, the compliance function 66 further can be programmed to specify one or more additional items of evidence (e.g., procedures, clinical data, studies, medications) that would improve diagnosis accuracy based on the guideline data 70 as well as an indication of the value for such improvement. The compliance function 66, for example, can be programmed to employ the diagnosis calculator 64 to compute an expected estimate of diagnostic accuracy based on the guideline data 70 for a given diagnosis. The compliance function 66 can further be programmed to compute a cost associated with performing the actions needed to support the diagnosis based on the guideline data 70.

As a further example, the compliance function 66 can indicate quantitatively how the accuracy (e.g., a confidence value) of the given diagnosis would change (e.g., an increase or decrease) based on the addition or removal of one or more supporting nodes associated with such diagnosis. Further analysis can be made to indicate how the cost associated with the diagnosis changes as the set of supporting actions changes to support the diagnosis. As mentioned, the suggested supporting nodes can, when accepted, result in action items being generated as “to do” notes appended to each respective node having an outstanding action. As actions may be performed (in full or in part), the progress for each such action can be updated in the attributes of the to-do data (e.g., data 51 of FIG. 2).

The guideline control 62 can be programmed to control which information and guidelines in the guideline data are available to the components of the guideline engine 60. For example, the guideline control 62 can expand or restrict the guideline data according to a user profile data specifying user role (e.g., stored in the whiteboard data 22). Examples of different user roles can include healthcare providers (e.g., physician, nurse practitioner, nurse, medical student, aid) and administrative personnel (e.g., billing coders, schedulers) or the like. Thus, depending on the different role of a given user, which can be determined according to the user ID logged into the system 10 (e.g., via data maintained locally at 22 or in a remote resource 36), the guideline engine 60 can provide different layers of functionality.

For example, if the user role comprises a coder, the guideline control 62 can be programmed to control the diagnosis calculator 64 and the compliance function 66 to employ the health data objects for the given patient to suggest one or more potential diagnoses, which could be supported by the evidence along with including the potential reimbursement values. The coder can send a message to a provider that made a given diagnosis to reconsider whether another diagnosis might be appropriate based on the set of supporting evidence that was obtained for the patient encounter. In some examples, the layer relating to a coder can reside as a cloud service that can be available for multi-tenant use, such as corresponding to an automated (fully or partially) coding service that can review evidence and diagnosis and generate suggestions that can be returned to providers for reconsideration to help maximize diagnostic accuracy, specificity and/or reimbursement.

The guideline control 62 can also be programmed to control the level of changes that can be made to nodes in the workspace based on user data (e.g., role information). For instance, the guideline control 62 can restrict changes that can be made autonomously depending on the role (e.g., qualifications) of the user. For instance, a medical student may require approval by an authorized physician before a given node can be added to a workspace for a patient encounter. Similarly, certain types of diagnosis may require approval by more than one authorized user, such as by a primary physician and a specialist (or supervisor) with a greater level of expertise in a given diagnostic related group. The rules employed to control how changes can be made to the workspace can be programmable by an authorized user.

As mentioned, the diagnosis calculator 64 may determine the existence of a relationship and a relevance of the relationship between node objects based on guideline data 70. The guideline data 70 can be a programmable and extensible data set that can be determined for a given practice or institution, such as based upon best practices. The system 10 can employ a default set of rules based upon national or local standards or as otherwise determined by the user or administrator of the system 10. The guideline control 62 can further be programmed to be user specific to apply selected rules defined by the guideline data 70 according to user data, such as user preferences data and/or user profile data stored in the whiteboard data.

Additionally, the guideline engine 60 can generate new rules which can be globally implemented within the system 10 or be user defined (e.g., part of the user data) to provide more flexibility to each user. For example, the guideline engine 60 can employ the documentation analytics 92 to learn new relationships, which can include global guidelines for a set of users or individual guidelines particular to a given user, and apply generate corresponding guidelines that can provide unique guideline data 70 for each user or different groups of users based on previous system usage data and user data.

The visualization system 16 can also include a view manager 69 to control the layout of information and how data is processed and stored based on the user data. For example, the user data can specify a role or context of the user, such as can be accessed and authenticated based on each user's login credentials. The user data can store information relating to each authorized user of the system. For example, the user data can include role data and preference data for each user. The role data can be stored in memory for each of the users and be utilized to vary or control the content and organization of the output visualization 14 for a user based upon the role data. For example, each user can be assigned a given role, such as a physician, nurse, patient, or other technical professional and, depending upon the role, different types of information may be presented in the output visualization 14.

In addition to different types of information, information may be presented in different ways depending upon the sophistication or technical expertise of the user defined by the role data (e.g., in whiteboard data 22). For example, more technical information may be provided for a physician than for a patient, which can also be a user. Additionally, different users at a given category may result in information being presented differently depending on each user's role data, such as identifying a particular interest or area of specialization. For example, a pulmonologist can have the output visualization 14 appear differently (with the same or different information) from the graphical map generated for the same patient where the user's role is defined a cardiologist. The visualization engine 18 can flex or morph the output visualization 14 based on the role data for each respective user. Additionally, a greater level of authorization and access to different types of information can be provided based on the role data.

Preference data, which can also be stored as part of the user data, can be utilized to set individual user preferences for the arrangement and structure of information that the visualization engine 20 presents in the interactive output visualization 14. For example, preference data can be set automatically by the system 10 based upon a given user's prior historical usage, which is stored as part the preference data. The view manager 69 can select and control the graphical representation of health data objects for use in generating the output visualization 14 and arrange such graphical elements (e.g., nodes and connections) in the map for a given instance according to the user preference data of a given user that is currently logged into the system. The system 10 can learn preferences and how to arrange objects based upon repeated changes made by a given user. For example, the system 10 can infer or employ machine learning from log data (e.g., data 52) that can be stored in memory in response to user inputs with the interactive workspace.

The system 10 can also include a logic flow system 74 that is configured to implement one or more logic flows associated with different tasks that can be performed by the system 10. The logic flow system 74 can include logic flow controls 76 and an execution engine 78. The logic flow controls 76 can be configured to control application of the logic flow system in response to instructions requesting execution of a selected logic flow, such as can be in response to a user input (e.g., activation of one of the GUI controls 12) or an automated instruction issued by a function or method operating in the system 10. For instance, the logic flow controls 76 can validate instruction requests and create an instance of the requested logic flow for execution of the execution engine 78. For example, a given logic flow can be specified by an identifier or name in the request, and the controls 76 can retrieve a configuration file for the specified logic flow from a logic flow configuration data 82.

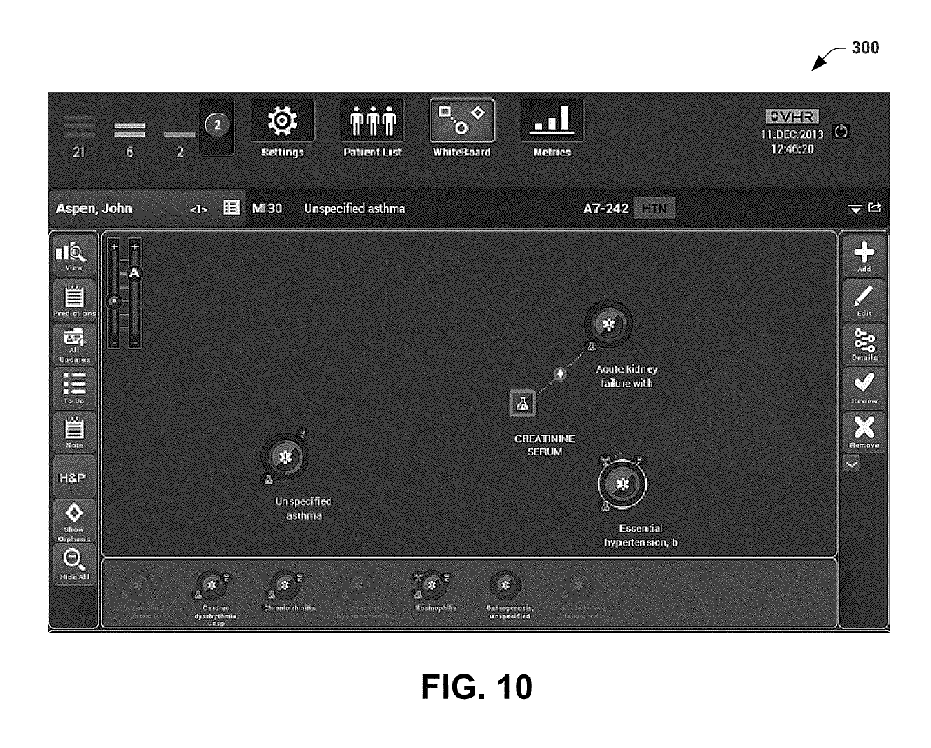

The execution engine 78 can execute the configuration file to perform the workflow tasks defined in the retrieved configuration file. For example, execution engine can execute the configuration file by traversing each of the steps, actions and parameters in each of the steps as well as traversing connections between steps. In order to execute the actions defined at each step, the execution engine 78 can employ a library interface 80 to access computer-executable methods corresponding to each action that is stored in a logic flow library 84. The library 84 can include a set of pre-programmed computer-executable actions, steps and/or flows that can be executed based on the parameters provided in a given configuration file and information generated during execution thereof. The controls 76 can also handle storing the data that is generated in response to performing the workflow tasks of a given logic flow in the data 22. As mentioned above, additional information about logic flow system is provided U.S. patent application Ser. No. 14/573,487, filed on 17 Dec. 2104, and entitled LOGIC FLOW GENERATOR SYSTEM AND METHOD, which is incorporated herein by reference. An example of how a logic flow may be executed in the context of the whiteboard system 10 is disclosed with respect to FIGS. 10-15.

As mentioned to above, the whiteboard system 10 can also include a documentation system 88 to document various forms of information that are generated during use of the whiteboard system 10, such as can include new patient health related information that is generated or updated and/or user interactions with the system. For instance, the documentation system 88 can include a document generator 90 programmed to record and store each interaction via the GUI controls 12, including for validating and invalidating new graphical elements or links between elements, as medical decision making information as part of the documentation data 53. In this way, such interactions by the user with the output visualization 14 can create a log (e.g., an audit trail) of patient management and review of clinical information for a given patient that can be stored as the documentation data 53. As disclosed herein, the documentation data 53 or a selected portion thereof can be pushed to the data repository 24 via the repository interface 23, such as in the form of a text-based note (e.g., text string) or other data form.

By way of further example, the document generator 90 can be programmed to generate the documentation data 30 by capturing a process of clinical decision-making in response to user inputs interacting with the workspace. For example, the GUI controls 12 can store UI log data (e.g., data 52 of FIG. 2) in response to each user interaction with nodes and relationships between nodes in the workspace, as well as use of the GUI controls 40, 42 and 44. In this way, each instance of manipulation or adjustment, creation or deletion of a graphical node or relationship between nodes can be stored as part of the patient data (e.g., log data) corresponding to the underlying health data objects and relationships represented thereby. The log data thus can be used to provide a detailed record of the decision making process of the user working on one or more patient diagnosis. In this way, not only does the whiteboard system 10 provide a visualization of a current (or historical) diagnoses and contributing factors (e.g., represented by the state of the graphical elements and relationships), but it also can store log data to record each intermediate step (corresponding to additions subtractions or changes) that occurred to arrive at such diagnosis.

As a further example, the document generator 90 can store the encounter data using a variety of standard codes according to the coding systems utilized by the healthcare enterprise using the system 10, such can include diagnostic codes (e.g., ICD-10, ICD-9, ICPC-2 and the like), procedure codes (e.g., HCPCS CPT, ICD-10 PCS, ICD-9-CM and the like) pharmaceutical codes (ATC, NDC, DIN and the like), topographical codes, outcome codes (NOC) or other relevant codes, including known or yet to be developed coding systems.

Once such documentation data 30 has been generated, including codes and related supporting evidence, the system 10 can employ the repository interface 23 to push the data to be stored in the data repository 24, such as for billing and/or clinical purposes. This push of data can be manual in response to a user input or be automated.

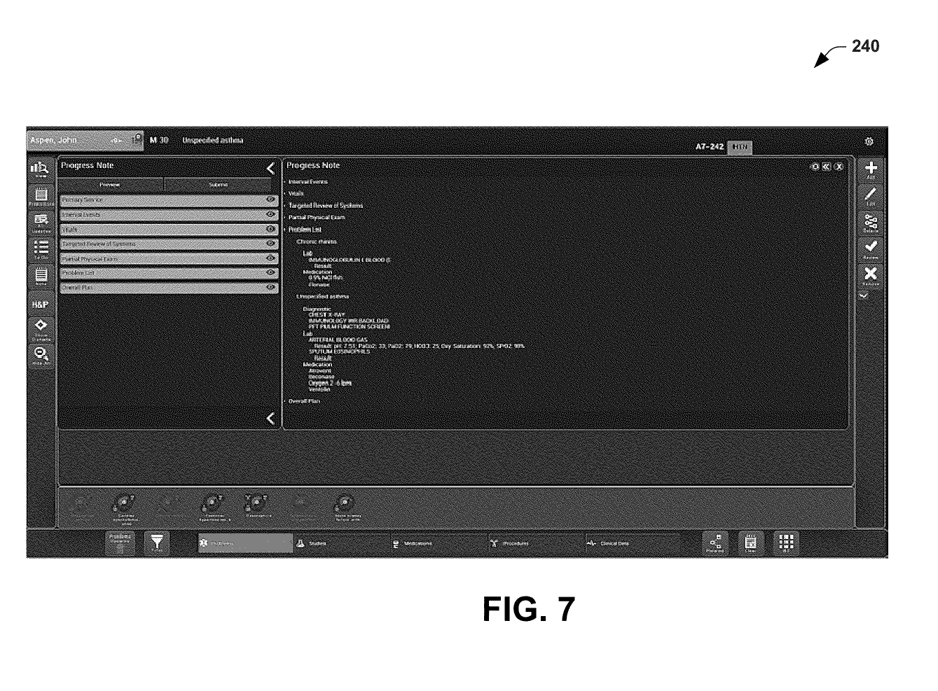

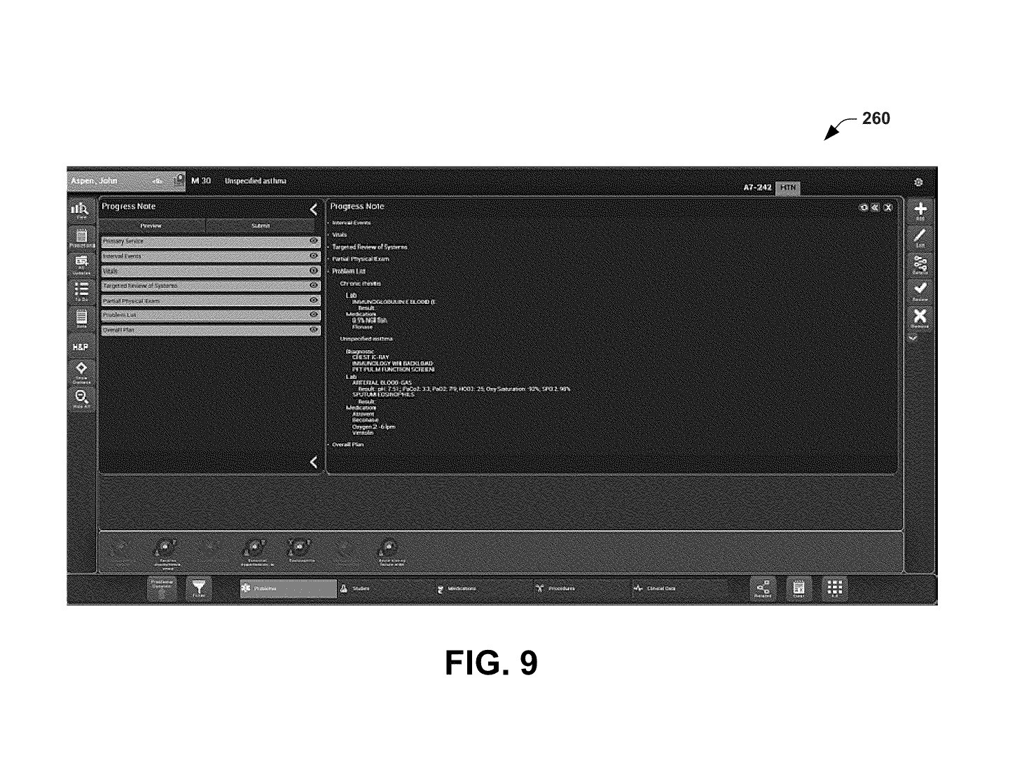

The document generator 90 can also implement a note generator function to create notes (e.g., progress notes—see e.g., FIGS. 7 and 9—or other freeform entry of information (e.g., text, audio, or audio-video) that a user may enter into the system 10 via the corresponding GUI controls 12. Such notes or other information can be stored (e.g., as text string, XML document or other readable form) as part of the patient record data 26 (e.g., as documentation data 53). The documentation system 88 or other controls in the system 10 can send the documentation data 30 to the EHR system 24 via the repository interface 23 (e.g., via HL7, a hidden web service or other application layer protocol) to push back log data and notes data that may be stored as corresponding health data objects or related notes for a given patient encounter. Similar methods can be employed to send other forms of data from the whiteboard system 10 back to the EHR system 24.

The document generator 90 can also be programmed to assemble or generate a user perceptible type of document (e.g., a report) based on the patient data 26 that can be stored in the whiteboard data 22. For example, the patient data can be stored in a known format (e.g., XML document), which the document generator 90 can utilize to create a corresponding user perceptible document (e.g., a PDF, a Microsoft Word document or the like). Such user perceptible document can be created based on metadata 28 and relationship data 30 representing links between related health data objects, corresponding to the graphical connections in the interactive whiteboard space of the output visualization 20.

The documentation system 88 can also include documentation analytics 92 to analyze user input actions, such including associations and nodes proposed by the guideline engine 60 and validated in response to user inputs as well as new nodes and associations generated in response to user inputs. The documentation analytics 92 thus can learn new associations between graphical elements and store such as new rules in the guideline data, for example. For instance, a relationship between nodes can be learned in response to repeated user validation or creation of a diagnosis data element and its association with supporting evidence data elements on the interactive visualization 14. The extent of the relationship can be computed based on a confidence value that is calculated based upon the relationship data or metadata that is provided with the respect of health data objects. The relevance between each pair of related health data objects thus can be stored as relevance data in attributes of the relationship data 30.

The whiteboard system 10 can also include a prediction function 94 that can be utilized to generate a prediction for a likelihood of a patient's outcome, such as a diagnosis, length of stay, readmission risk, patient satisfaction or other outcomes for a patient or group of patients. In some examples, the prediction function 94 can access a web service (e.g., one of the other resources 36) or a logic flow that is programmed to compute a predicted likelihood for a selected condition associated with a patient encounter. In addition to predicting patient outcomes, the prediction function 94 can be utilized to generate a prediction for administrative conditions. Administrative conditions can include quantifiable information about various parts of a facility or institution, such as admissions, capacity, scheduled surgery, number of open beds or other conditions that may be monitored by administrative personnel or executive staff. The type of prediction algorithms and models that can be utilized can vary according to the type of condition or outcome being predicted and the type of information to be presented by the whiteboard system 10.

As a further example, the GUI controls 12 may also include a button or other GUI element corresponding to a prediction control element can be configured to integrate to one or more predetermined web services (e.g., specified by URL). Activation of the prediction control can provide a list of available predictive algorithms, such as can be grouped by specialty, for example. In other examples, they can be grouped based on the user profile data, such as based on user's predefined preferences and/or based on the user's role/specialty. The prediction control further can be programmed for enabling data entry of necessary input, invoking algorithm and displaying result in the whiteboard workspace.

The user data can also be utilized to establish access to the system 10 via a plurality of different types of display devices, each of which may be presented the output visualization 14 differently, such as depending upon the display capabilities of such device. Each device can still employ the GUI controls 12 to perform the functions disclosed herein. The manner in which such controls are implemented graphically and accessed by a user can vary depending upon the device.

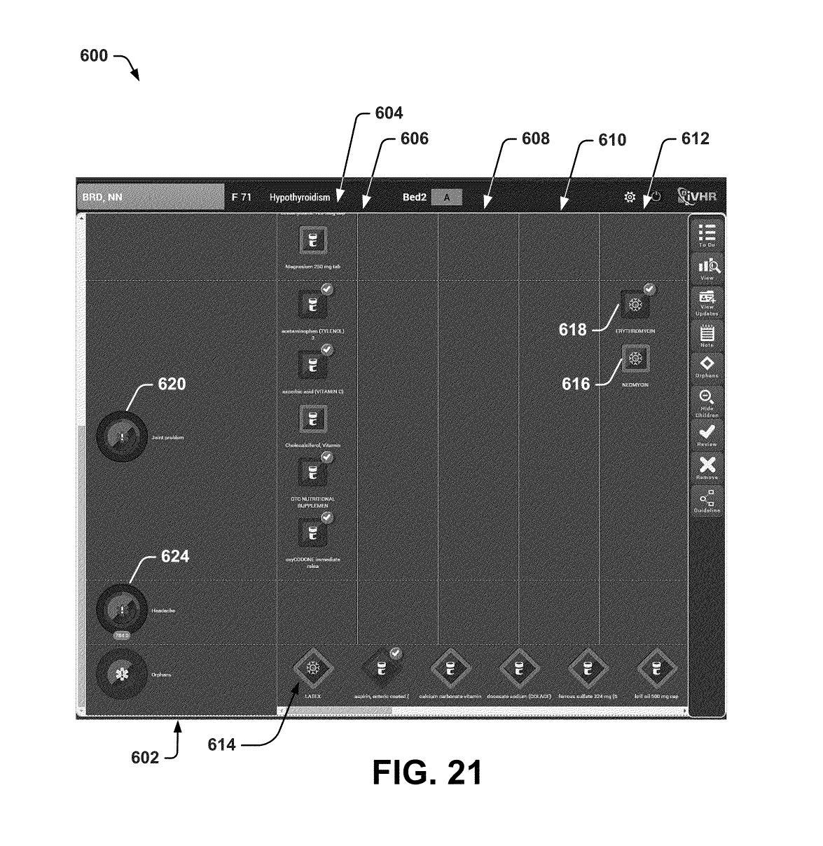

By way of further example, FIGS. 3-22 depict example screen shots demonstrating various examples of functions and methods that can be implemented by whiteboard system 10, such as disclosed with respect to FIG. 1.

FIG. 3 depicts an example of an output visualization (e.g., output visualization 14 of FIG. 1) 200 that provides an interactive graphical map for providing access to functions and methods to control the visualization of data and relationships among such data as disclosed herein. In the example of FIG. 2, the visualization 200 includes GUI controls (e.g., controls 12 of FIG. 1) distributed around the interactive workspace 208 of the visualization 200. In this example, the interactive workspace 208 is empty (e.g., no nodes) and the GUI controls include a set of global GUI controls 202, a set of data type management controls 204 and a set of node GUI controls 206. The global GUI controls 202 can correspond to the global controls 40 of FIG. 1 and provide access to performing functions globally across the encounter data for a given patient, which in this example is demonstrated as John Aspen.

An example of various types of global controls 202 are demonstrated in a control panel 209 FIG. 3A. For example, an “All Updates” control element can be activated in response to a user input to displays all “new” or “updated” data points in the workspace. This can be set to provide a recent snap shot of the available encounter data for a given patient, for example, since the last time the current user reviewed the data.

Also in FIG. 3A, the “To Do” control element can be activated in response to a user input to provide reminder list of action items in the workspace visualization. As an example, the items in the list grouped by High Priority vs. low priority. High priority and low priority can be visualized differently such as by different colors to indicate different levels of priority (yellow vs. orange) or by employing other graphical discriminators (e.g., different sizes, animation or the like. Additionally, in some examples, high priority items can trigger notifications, such as to indicate when the item has been completed. For instance, a notification can be sent to one or more users when lab results are published.

In the control panel 209 of FIG. 3A, The NOTE control element can be activated in response to a user input to provide templates for entering notes. For example, the control element can be configured to open a list of note templates that the current user is authorized for based on user data (e.g., the user's role and preferences). In response to activation of the note control element, a note template wizard can be activated, walking the user through the note completion process (e.g., the note process can be implemented by the logic flow system 74 of FIG. 1).

The Orphans control element shown in FIG. 3A can be activated in response to a user input to show the nodes that do not have any relationships with one or more other nodes. Additionally, the control element can be de-activated to Hide Orphan nodes. This can toggled to show or hide orphan nodes.

The Show Children control element can be activated in response to a user input to pull all data points for display in the whiteboard workspace. Depending on the quantity of nodes, the data can be filtered automatically to present selected subset of the nodes and interconnections, which can further vary depending on the device (e.g., screen size and resolution) where the system is displaying the results. Such results further can be filtered according a relevance computed for the current user.

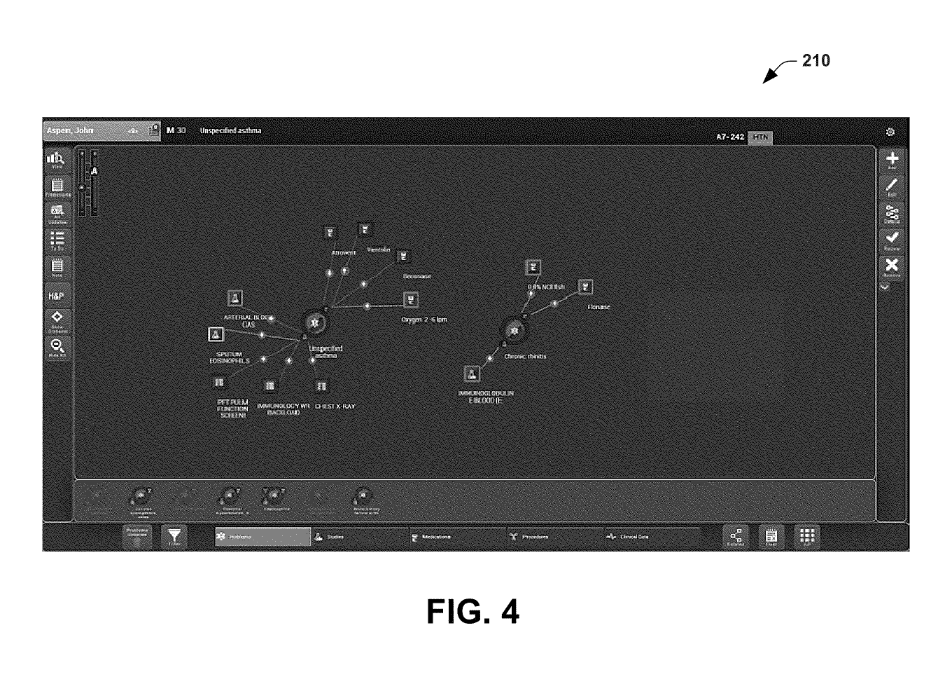

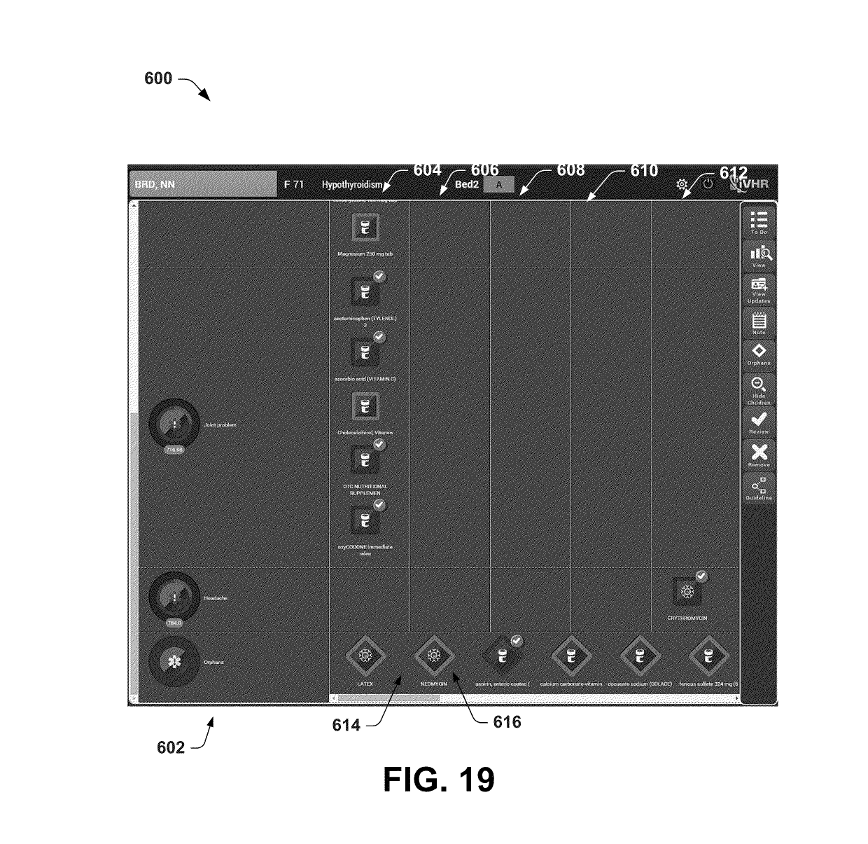

As mentioned, there can be more than one viewing mode, which can be selected via a View control element. For example, the view control element can expose additional control elements (e.g., buttons or the like) to select a desired viewing mode, such as including a node view, a text view or a matrix view. The node view displays nodes, corresponding health data objects, and relationships between nodes via graphical connections (e.g., lines) in the workspace, such as shown in FIGS. 4, 5, 10, 12 and 15-18. The node view may be referred to as solar (system) view where each problem node is located at a center of a cluster and supporting nodes radially distributed around the problem node by radial extending connections. The text view displays the health data objects and relationships between such objects as a text document (e.g., problems list) in which supporting evidence is listed below related problems in a hierarchical and/or tabular manner. The matrix view of the interactive workspace can display graphical nodes for problem health data objects in a first column and each supporting node in the same common row as the problem node to which it is related, such as shown in FIGS. 19-22. Thus, more than one instance of a given supporting node can exist in multiple rows of the matrix view.

As an example, the view control can be configured to selectively change the interactive workspace between the different viewing modes in response to a user input selection. Thus, in the node mode the interactive workspace is generated (e.g., by visualization engine 20) to represent relationships between the supporting evidence and related health problems as graphical connections between related health data objects in the interactive workspace based on the relationship data. In the matrix viewing mode, the relationships between the supporting evidence and related health problems are represented by presenting related health data objects in a common spatial area (e.g., a given row of a two-dimensional matrix) in the interactive workspace based on the relationship data.

As demonstrated in FIG. 3, an H&P (History and Physical) control element can be activated in response to a user input to provide templates for taking history and physical examination information for a patient. Similar to the note control element, the H&P control element can be configured to open a list of H&P templates based on user data for the current user (e.g., selected according to the user's role and preferences). In response to activation of the H&P control element, a corresponding template wizard can be activated, walking the user through the note completion process (e.g., the H&P process can be implemented by logic flow system 74 of FIG. 1).

FIG. 3 also demonstrates data type controls 204 that can be utilized to implement functions and methods relating to the management of the type and content of data that the visualization system provides in the visualization space of the output visualization 14. The data type level GUI controls 204 can correspond to the data type level controls 42 of FIG. 1 and the GUI controls 204 thus allow management of the type of data and information that is presented in the graphical map for the corresponding patient encounter. In this example, the data type controls include a problem update control element, a filter control element, a problems control element, a studies control element a medications control element, a procedures control element and a clinical data control element. In some examples, the data type controls can include controls elements to constrain what type and how many objects and associations are visualized in the space. The controls can include a control element to display related objects, a control element to display all objects and associations and another control element to clear (e.g., reset) the data type controls to provide a default view.

The ‘Updates control element can be activated in response to a user input to retrieve updates for the currently selected data type (e.g., Problems, Studies, Medications, Procedures, Clinical Data). Similar to “All Updates” button in global control navigation but only pulls updated data points of the currently selected data type,

The Filter control element can be activated in response to a user input to implement a data filter for one or more selected data types (e.g., Problems, Studies, Medications, Procedures, Clinical Data). For instance, activation of the filter control element can open a list of “groups” that can be filtered for the selected data type. Each group that exists can be selected or deselected to control which items are shown in the workspace. For instance, shaded (e.g., deselected groups) items are not shown in the workspace, and selecting a given group will pull all items in that group into the workspace. A group that has some items on the board and some in the ribbon can provide a GUI element (e.g., an up arrow and a down arrow) allowing the user to choose to pull the remaining items into the workspace or off onto the ribbon. Examples of activation of the filter control element as demonstrated herein with respect to FIGS. 2A, 15 and 16.

The Data type control elements can be activated in response to a user input to select one or more data types to be presented in the whiteboard workspace and/or control the filter controls, for example. The selected data types (e.g., Problems, Studies, Medications, Procedures, Clinical Data) thus sets context for the ribbon, displayed directly above buttons and associated GUI elements (e.g., buttons) that can include a Related button, a Clear button and an All button. The Related button can be selected to pulls items of the currently selected data type from the ribbon onto the workspace if they are related to the problems currently on the workspace. Also reverse control can be implemented, such as, for example, if a study is in the workspace but the related problem is not displayed, a user can select “Problems” data type and “related” button and it will pull that problem onto the workspace. The clear button can be activated by a user to clear all items of the currently selected data type off the workspace into the ribbon. The All button can be activated by a user to pull all items of the currently selected data type off the ribbon into the workspace.

The node level controls 44 can be programmed to enable interactions with individual nodes, corresponding to health data objects. As demonstrated in the example of FIG. 3, the node controls (e.g., corresponding to node controls 44 of FIG. 1) 206 can include an Add control element, an Edit control element, a Details control element, a Review control element and a Remove control element. For example, the add node control 44 can enable an authorized user to create new nodes, such as corresponding to one or more health data objects. For example, the health data objects represented as nodes can include problems, studies, medications, procedures and clinical data (e.g., tests). Each type of data can be provided a different type of visualization to help graphically distinguish the different types of data being represented in the interactive whiteboard workspace. The node level controls 206 can also be employed to create relationships between health data objects represented by nodes in the interactive workspace. The node controls 44 can be programmed to edit a selected one of the nodes in the output visualization in response to user inputs, such as can be made via a pointing element that is controlled by a user input device (e.g., a mouse, touch-screen, or other human machine interface). Thus, the node controls 44 are programmed to provide for user interaction and manipulation of the interactive output visualization 14 and its various components that are presented as part of the graphical map. Thus, a user can employ the user interface to access the functions provided the node controls to perform corresponding functions.

As a further example, the Add element can be activated in response to a user input to add a new node onto the board, which can create a corresponding entry in the node data 28. The node can be of any node type and the activation can control the type of the new node according to a context of related actions. For instance, when a problem node is selected and then the Add button activated, the “add” action is in context of that selected problem. Lists of studies, medications etc. are based upon the guidelines or history in relation to that problem. Also, added items can be automatically connected to that problem. Additionally, as other nodes are related to a given problem node, the metadata of such problem node can also change. For example, a supporting unit of clinical data (e.g., a lab or test) can indicate a severity level (e.g., mild, moderate, severe) of the problem health data for the node to which the supporting data has been related. The severity, for example, can be stored in the whiteboard data 22 as part of the node attributes in the metadata corresponding to the connection between respective nodes (see, e.g., FIG. 2).

The Edit control element (e.g., corresponding to a data type control 42) can be activated in response to a user input to change a problem code for an existing problem node. The code can be implemented according to one or more coding systems utilized by the enterprise using the system 10. For example, the codes can include diagnostic codes (e.g., ICD-10, ICD-9, ICPC-2 and the like), procedure codes (e.g., HCPCS CPT, ICD-10 PCS, ICD-9-CM and the like) pharmaceutical codes (ATC, NDC, DIN and the like), topographical codes, outcome codes (NOC) or other relevant codes, including known or yet to be developed coding systems. For the example of ICD codes, the initial list of problems that are presented for selection can be those problems in the same ICD family (e.g. if current ICD is 428.1, then it shows all problems in 428. A user can scroll the list down to 428.1 assuming selection will be more specific (lower). Filter functions can be activated in response to a user input to control the types or families of problems and supporting evidence nodes in the interactive workspace provided by the output visualization 14.

The Details control element can be activated in response to a user input to show details of selected node, such as lab order date, by who, results, result published date, etc. The Review control element can be activated in response to a user input to help graphically differentiate a selected group of nodes. For example, “new” or “updated” nodes can be visually emphasized to the current user by visually representing such nodes by a different color border (e.g., a green border). Selecting a lab node and viewing the details marks it as “reviewed”. A similar action as clicking the review control element. Other “new” or “updated” nodes can be marked as “reviewed” (acknowledged that they exist and have been seen) by clicking the “review” button. Selecting a problem node and clicking “review” can also mark all children as reviewed. The process of reviewing nodes and associated details further can be documented and stored in the local data (documentation data 30) to provide a trail of such actions for a given user.

A Remove control element can be activated to remove a selected data object and its corresponding associations. The underlying removal function can be contextual, such that the particular action implemented will depend on the state of the object that has been selected for removal by a user. For example, a node that was added by the user and does not yet exist in the data repository (e.g., an EHR system) 24 can be removed by selecting the node and clicking remove. Once it exists in the repository 24 (or if it originated in the EMR) the underlying data may be persistent and locked to prevent its removal. Nodes that were recommended by the Guideline Engine 60 can be selected and removed in response to activating the Remove control element, only prior to existence in the data repository. Connections between nodes, either manually created nodes or those recommended by guideline engine, can be removed at any time. In other examples, nodes for problems or other data nodes can be remove even if such data objects are stored in the repository 24. The process of removing nodes and/or connections between nodes further can be documented and stored in the local data (documentation data 30) to provide a trail of such actions for a given user.

FIG. 4 depicts of an example of whiteboard output visualization 210 in which the graphical map is populated by corresponding nodes and connections between related nodes. In the example of FIG. 4, two problem nodes are demonstrated, including one for unspecified asthma and another for chronic rhinitis. Supporting evidence associated with each of these respective problems are demonstrated as being associated via corresponding connections as disclosed herein, connections between respective nodes can be made automatically and/or in response to user inputs via the respective GUI controls 202, 204 and 206 (FIG. 3). A user can also interact with the respective nodes and connections via such controls or directly, such as by dragging and dropping them in selected positions within the whiteboard workspace. As another example, a user can hover a pointer or otherwise activate a given node or connection to provide additional details, such as can be stored in patient data 26 that is accessed via a link 54 in the node metadata 28 for the respective patient encounter (e.g., as the whiteboard data 22 of FIG. 2).

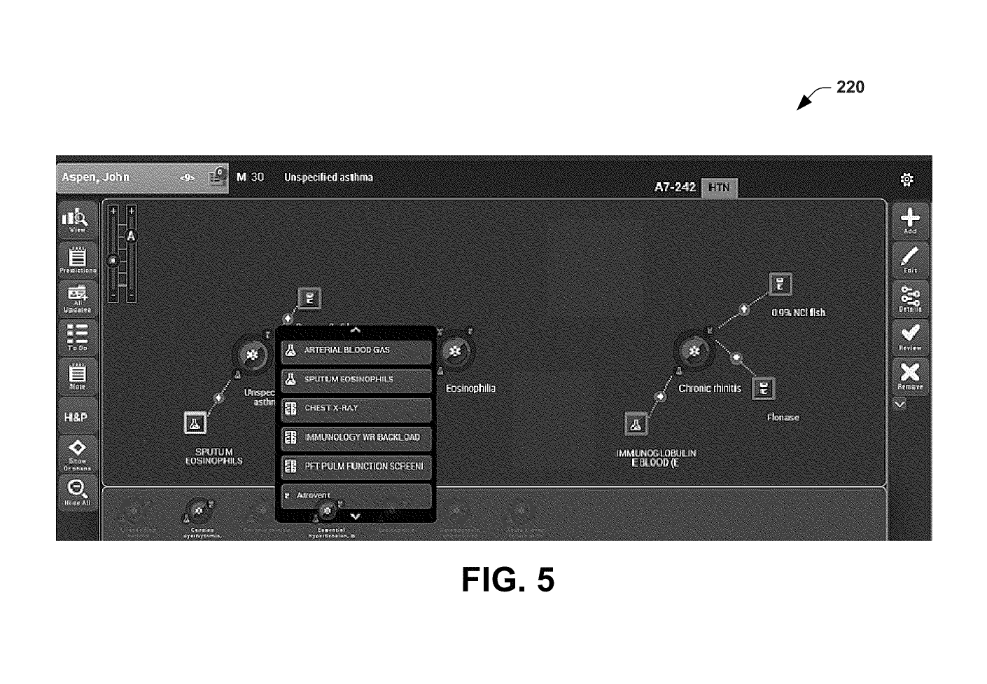

FIG. 5 depicts another example of the workflow output visualization 220 corresponding to the visualization of FIG. 4 in which a given node (for unspecified asthma) has been activated to provide a corresponding guidelines list associated with the selected problem. For example, the guidelines list can be generated by a guideline engine 60 of FIG. 1 based on the corresponding guideline data 70. In this example, the guideline list provides corresponding supporting evidence for the selected problem based upon medications, studies and critical data that may have been obtained for the given patient encounter. In other examples, the guideline list can also provide additional interventions that can be performed that can further validate or confirm the problem as a diagnosis. A user thus can select one or more of the guidelines from the list and in turn populate them associated with the selected problem node.

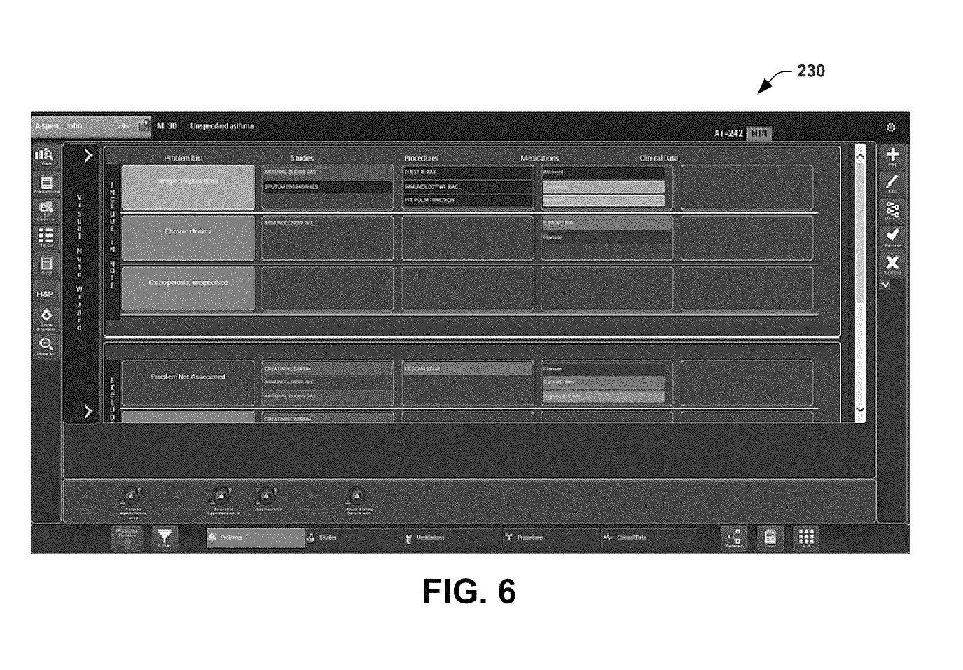

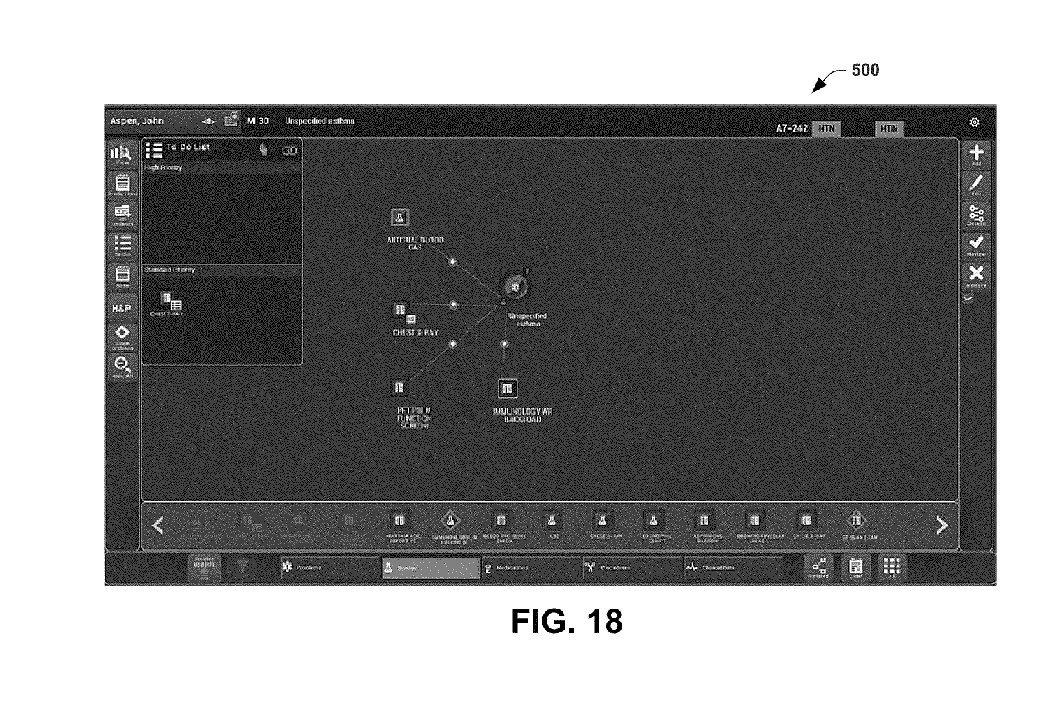

FIG. 6 depicts an example of an output visualization 230 corresponding to a visual note that provides a tabular graphical representation of the information provided in FIGS. 4 and 5, for example. Thus in this example, the heath data objects are organized as a series of rows and columns corresponding to a visual note. A user, for example, can switch between the visual tabular view of FIG. 6, the matrix view (FIGS. 18-22) and the node view of FIGS. 3 and 4 by employing corresponding global GUI controls to switch between respective views, such as view controls shown in FIG. 3A. Similar to the node graphical view, the tabular view of the workflow visualization 230 in FIG. 6 enables interaction with each of the respective graphical objects.

In the example of FIG. 6, the graphical objects in the note wizard include problems provided in a problem list, studies, procedures, medication and clinical data. Each of the respective health data objects that have been associated with a respective problem are provided in a common row. It should be understood that a given health data object for a study, procedure, medication or clinical data thus can exist in multiple problem rows if the underlining data supports multiple problems. As demonstrated in the example of FIG. 6, the tabular view for the visual note wizard interface includes a first workspace portion that includes problems, studies, procedures, medications and clinical data that are to be included in a note as well as another workspace portion of problems which are to be excluded from the note. Thus, a given user can selectively control what is to be included and what is to be excluded from the note, such as by dragging and dropping a corresponding health data object from the included area into the excluded area. This can be implemented, for example by selecting a corresponding object and dragging it from its current area to its current area. If, for example, in order to generate a corresponding progress note based upon the set of health data objects in the area identified as to include in the note, a given user can activate the “note” global GUI control to activate a note generator (e.g., documentation generator 90 of FIG. 1) that will in turn generate a corresponding progress note based upon the data that has been identified as to be included in the note.

FIG. 7 demonstrates an example of an interactive workspace 240 that includes an outline for a corresponding progress note that can be generated based upon the data presented in FIG. 6. Thus, in this example, data acquired from a corresponding EHR can be included in the note as well as the problem list from the tabular graphical view of FIG. 6 in which the current problems include unspecified asthma, chronic rhinitis and osteoporosis (unspecified). Supporting data, including studies, procedures, medication and clinical data associated with each respective problem can in turn be listed along with the results and underlining data for each respective health data object. The note in turn can be submitted and returned through a corresponding interface 23 to the data 25 in the EHR system 24.

In the example workspace visualization 240 for the progress note, the progress note includes several sections, including information about a primary service, internal events, vitals, positive review of systems, partial physical exam, problems list and overall plan. In this example, the details demonstrated in the workspace visualization 240 correspond to the problem list section which can be obtained and corresponds to the problem list to be included in the note identified in the visualization 230 of FIG. 6. A user can preview or submit the progress note by activating the corresponding GUI element (e.g., demonstrated as preview and submit radio buttons). Alternatively, if a user wishes to make modifications to the problem list, for example, a user can return to the tabular view of FIG. 6 (or solar view of FIG. 5) and make the corresponding modifications. For example, from FIG. 6, if the user wishes to exclude a given problem and its associated health data objects from the note, a user can drag the problem from the included note area to the excluded from note area (e.g., ribbon area) below.

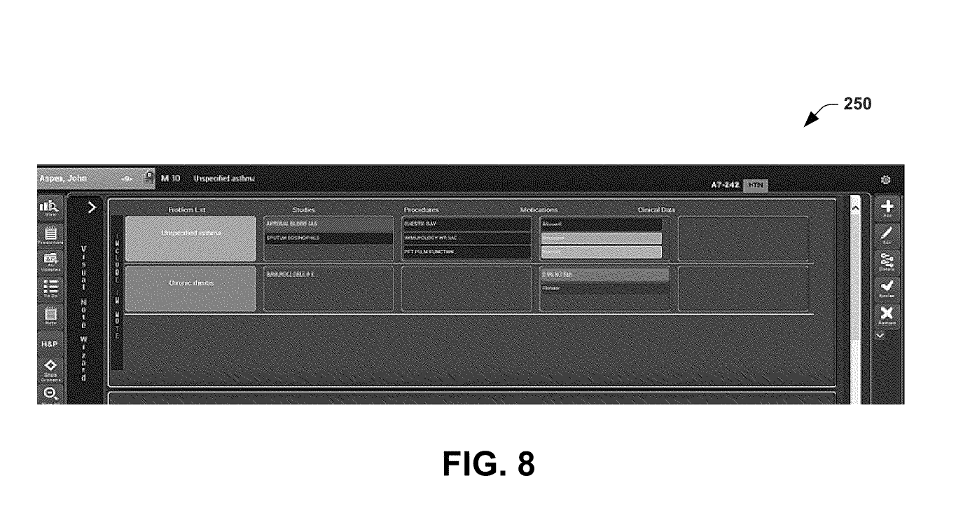

FIG. 8 demonstrates an output visualization 250 in which the osteoporosis unspecified problem has been removed from the included in note section, such as by clicking on the problem list data object and dragging it into the excluded from note section of the interactive visualization 240 of FIG. 5. Thus, in the example of FIG. 8, the problems to be included in the progress note include unspecified asthma and chronic rhinitis. However osteoporosis and specified problem is to be excluded from the progress note. It is to be understood that each of the containers and associated health data objects for studies, procedures, medications and clinical data can be removed automatically with its associated problem. That is, for example by dragging and dropping a corresponding problem from one of the included/excluded areas to the other area each of the respective associated health data objects are also moved along with the problem to which they have associated. As a result, manipulation of a corresponding problem note can be greatly facilitated by a user.

The tabular form of the output visualization 250 of FIG. 8 can be further visualized as a progress note by activating a corresponding note “global control” to provide the output visualization 260 demonstrated in FIG. 9. In this example, it is to be appreciated that the whiteboard system can be programmed to obtain data for each of the various sections in the progress note from one or more data sources, including the data repository (repository 24, other resources 36 and the local whiteboard data 22 of FIG. 1). Since the osteoporosis problem has been excluded from the to-be-included section of the tabular list of FIG. 8, the corresponding description of its problem and its associated health data objects (e.g., the studies, procedures, medications and clinical data) related to such problems has also been removed from the corresponding progress note preview demonstrated at 260 in FIG. 9. Additionally the changes that have been made in the tabular view, including as represented in the progress note, can further be reflected in the solar graphical representation whiteboard output visualization such as demonstrated in the example of FIG. 4 or 5. Thus, in this example the corresponding excluded problem and its related associated supporting evidence can in turn be visualized in the excluded ribbon area residing between the whiteboard workspace and the data type controls demonstrated along the bottom of the workspace. Thus, the tabular views, matrix and the solar view can correspond to different ways to visualize the same type of health data which can be selected based on user preferences.

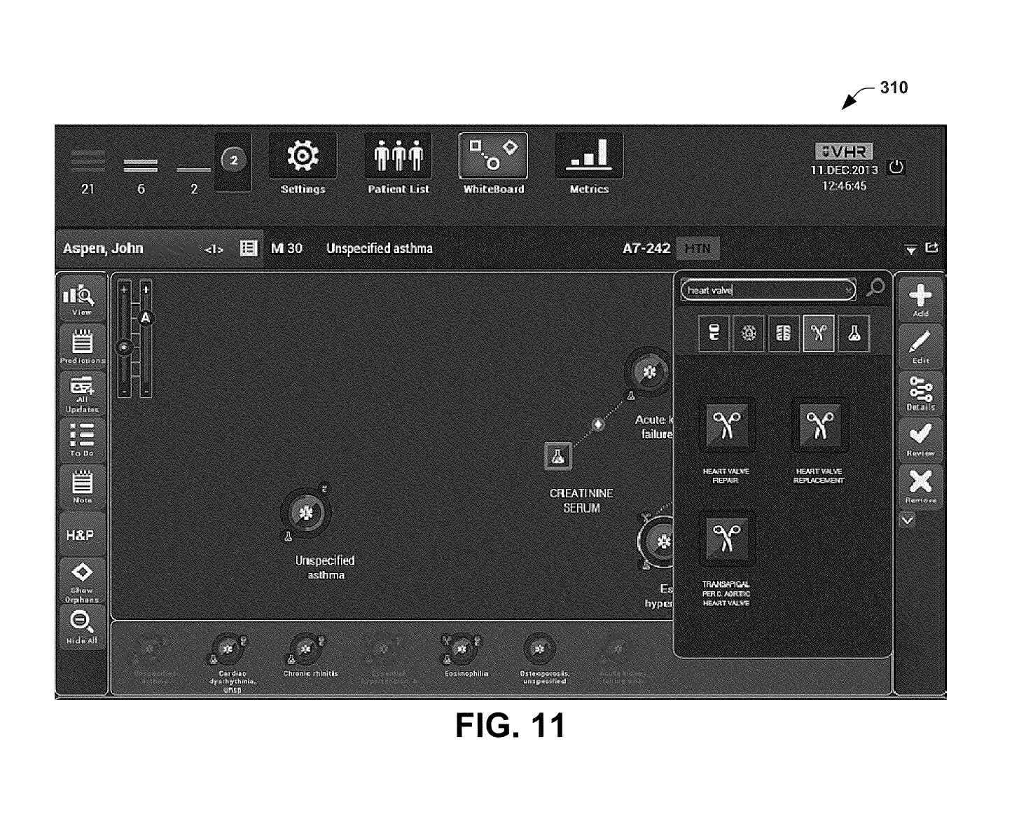

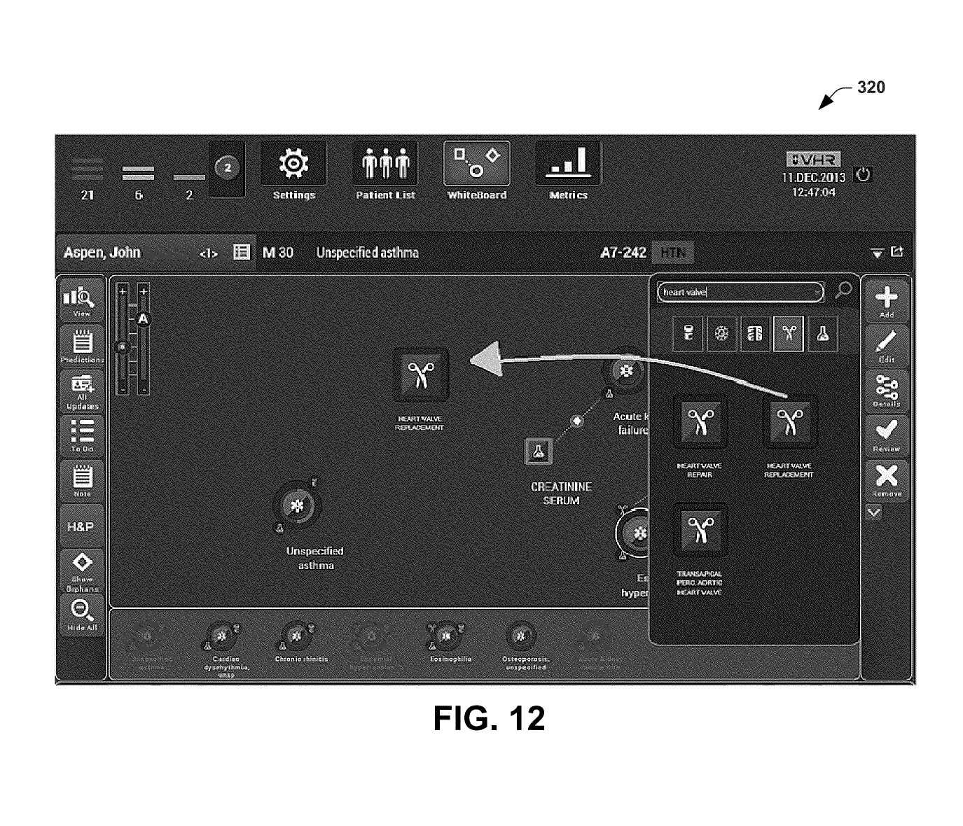

FIGS. 10-15 demonstrate an example graphical user interface in connection with using the whiteboard system to generate a procedure in an automated manner employing the logic flow system 74 of FIG. 1. The example of FIGS. 10-15 will be described in the context for creating a procedure for a heart valve replacement as an example assuming that the problems and associated supporting evidence support a corresponding procedure that is to be performed on a given patient. A user can add a procedure node to the graphical map of the output visualization 300 such as by activating the ‘Add’ node control GUI element. In response to activating the ‘Add’ GUI element, a corresponding ‘Add’ node pop-up menu can be activated and displayed over the output visualization, as shown at 310 in FIG. 11. The corresponding add node display can include a search dialogue box in which one or more terms can be entered for searching for a respective node. Additionally the type of node that is to be added can be selectively activated in response to a user input. Based upon the terms and the selected type of node (being a procedure node) a set of potential nodes matching the search criteria can be presented in the corresponding space of the window. In this example the corresponding matches include ‘heart valve repair’, ‘heart valve replacement’ and ‘transapical percutaneous aortic heart valve’. In this example, it is presumed that the user selects heart valve replacement GUI element, as demonstrated in FIG. 12, which results in the corresponding heart valve replacement node being generated and visualized in the graphical map, such as in an open area spaced apart from the other nodes.

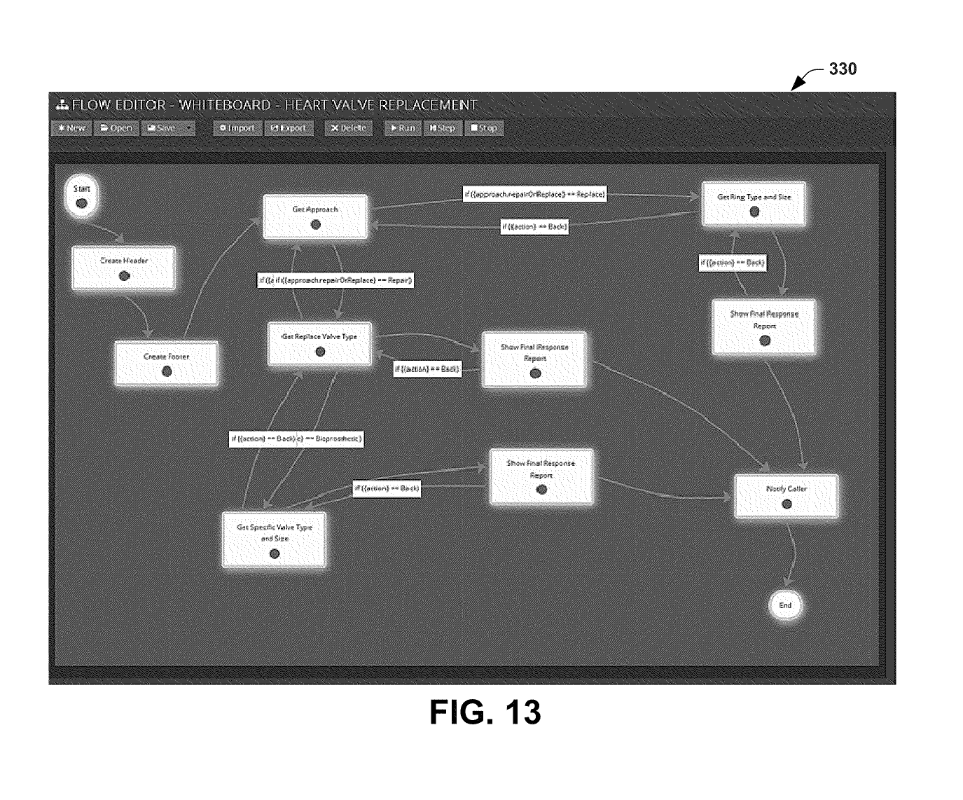

In response to the selecting the heart valve replacement node to be added to the whiteboard visualization space, a corresponding logic flow can be activated such as by the logic flow system 74 of FIG. 1. For example, the logic flow system 74 can employ logic controls to locate a corresponding configuration file for the heart valve replacement logic flow. The configuration file can represent a corresponding workflow, which includes steps and connections. The execution engine 78 can traverse the configuration file and employ the library interface to access corresponding executable actions to implement the logic flow based upon the parameters specified in the associated configuration file. FIG. 13 depicts an example of a logic flow that can be implemented for heart valve replacement, and Appendix C demonstrates an example of the corresponding configuration file.

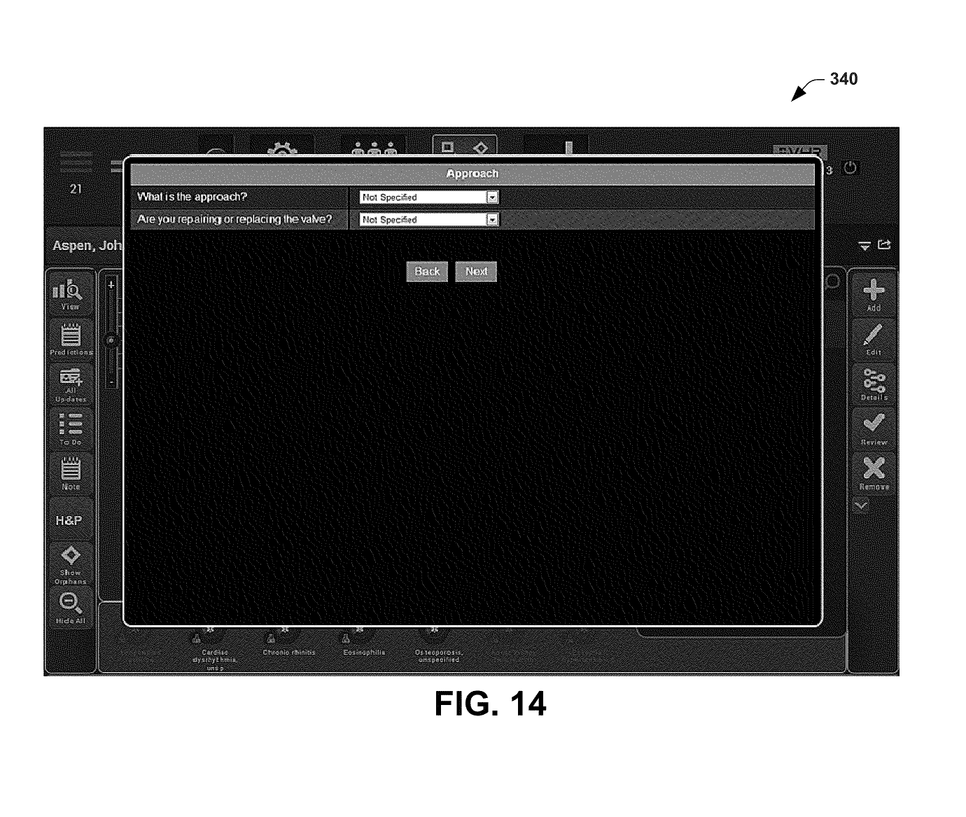

FIG. 14 in turn demonstrates an example of data collection GUI screen 340 that can be generated in response to execution engine implementing the logic flow and rendered over the whiteboard workspace for and an Approach step of the logic flow. The GUI 340 is utilized to obtain information regarding an approach and whether the valve is being repaired or replaced, which information can be obtained by the execution engine. The information obtained during execution of the logic flow can be stored in the data 22 such as corresponding to relationship data 30 associated with the heart valve replacement node that has been added. After the approach data has been entered by the user, the user can select to traverse the logic flow by either going to the next step or back to a proceeding step in response to a user input.

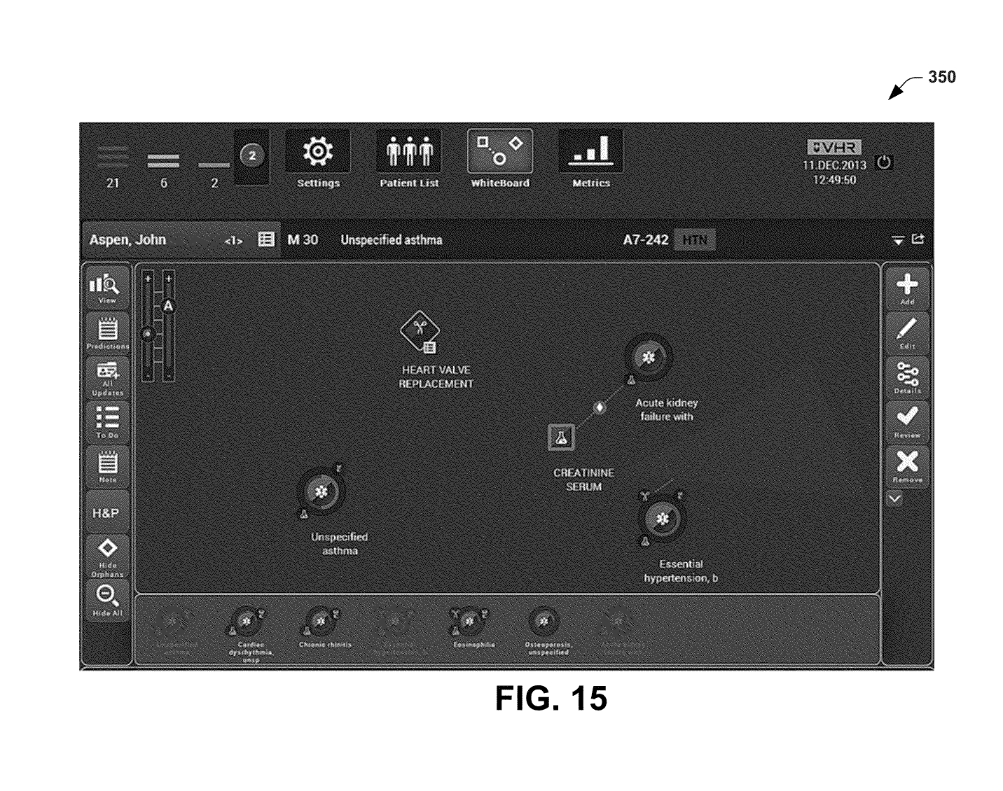

After the logic flow has been completed for describing the newly added node, in this example being for a proposed procedure, a corresponding to-do list can be generated and associated with the heart valve replacement node as demonstrated in the whiteboard output visualization 350 demonstrated in the example of FIG. 15. The to-do list thus can correspond to an operational node, such as including a pre-operational plan for performing the corresponding procedure. In response to creating the pre-operational plan using the logic flow, one or more appropriate orders for any additional testing that may be needed prior to or concurrently with performing the plan care can also be generated by the system (e.g., by another corresponding logic flow). The corresponding procedure can also be added to calendars and scheduling information, which can be implemented as part of the logic flow or, alternatively, another logic flow can be executed to initiate and complete the scheduling of the procedure, including the facility planning, personnel planning and equipment planning. The data obtained during execution of the logic flow and the corresponding to-do list can be stored in the data 22.

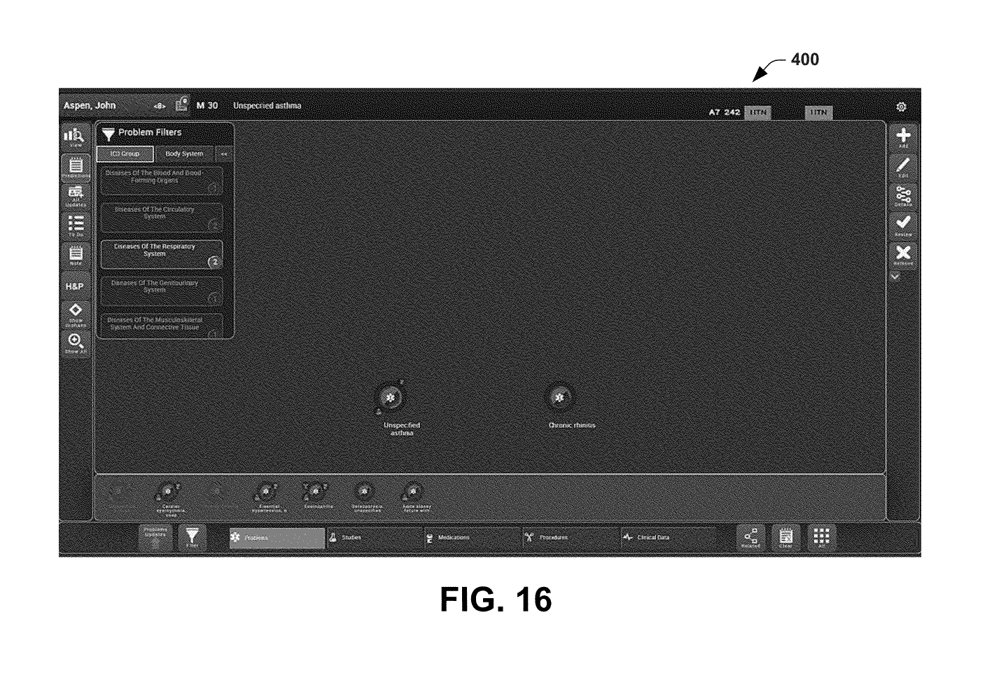

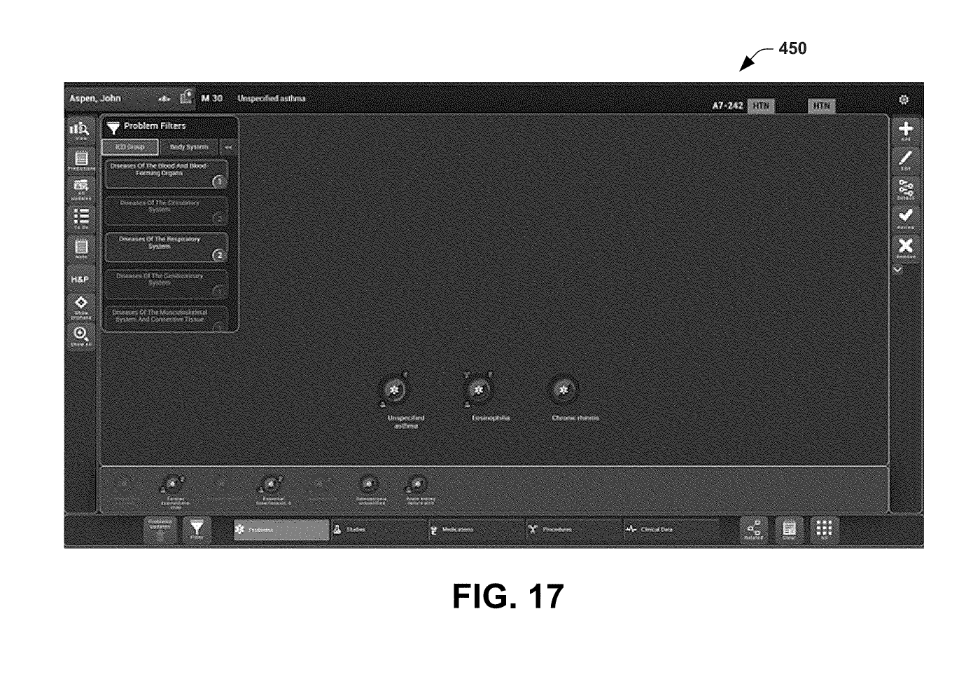

FIGS. 16 and 17 demonstrate respective whiteboard visualizations 400 and 450 resulting from applications of a filter function being activated associated with one of the data type controls (e.g., controls 15 of FIG. 1).

In example of FIG. 16, the filters have been activated in conjunction with the ‘problems’ data type (e.g., according to type data 57 in node metadata 28 for each respective node). It is to be understood that the filter in function can be implemented in conjunction with one or more selected of the data types including problems, studies, medications, procedures and clinical data. In this example, with the filter function activated for the ‘problems’ data type, only data object nodes meeting filter criteria are presented in the whiteboard workspace. In this particular example, the problem filter has been specified according to an ICD group listing mainly diseases of the respiratory system. Other criteria can be utilized as filtering criteria, such as by filtering based on one or more specified body system or subsystem, for example. The resulting graphical nodes demonstrate in the workspace 400 include unspecified asthma and chronic rhinitis.

In response to activating the filter for the selected problem data type, a problem filters GUI can be generated and presented in the workspace of the whiteboard GUI. The problems filter GUI can include GUI elements such as buttons or the like for identifying the type of filters to be activated for the selected data type (e.g., problems). For example, the filter can be established based upon an ICD group description, as demonstrated. In this example, the ICD group description has been selected such as in response to a user input or by a default function. In other examples, other filter criteria can be established via the problem filters GUI, such as for a body system or the like.

As the result corresponding descriptions of the ICD group can be presented in the GUI workspace. The set of the ICD group descriptions presented in the workspace GUI can be generated based on which ICD groups each of the respective problem nodes and the underlying data objects fit into. Each of the descriptions can be organized in the problem filters lists according to various sorting criteria such as alphabetical, quantities of different problems, based on relevance to a user's role, or a degree of urgency, such as may be computed by the guideline engine 60. Each relevant ICD group description can also include a numerical indicator that specifies the number of problems currently categorized in a corresponding ICD group. Each of the ICD group listings further can be provided as an actionable filter GUI element that can be selectively activated to control which problem nodes are presented in the whiteboard workspace 400.

In the example of FIG. 16, the ‘diseases of the respiratory system ICD group’ filter has been selected, thereby resulting in the nodes for unspecified asthma and chronic rhinitis being presented in the whiteboard workspace. It is to be understood and appreciated that one or more other ICD group filter elements could be selected to result in additional or other combinations of problem nodes being visualized. For example, in FIG. 17 an additional ICD group filter element (“diseases of the blood and blood-forming organs”) has been selected resulting in an additional problem node for eosinophilia node being also populated in the whiteboard workspace 450.

It is to be understood and appreciated that the examples of FIGS. 16 and 17 demonstrate filters being selected for problems type of data but similar filters could be generated for each of the other types of data including studies, medications, procedures and clinical data individually or in combination thus the filter function enables a user to focus in the filter criteria to control the types of information being presented in the whiteboard workspace such as can be selected based on the ICD group, or the body system of relevance to the each individual user. As disclosed herein, the ICD group and body systems further can be refined according to the user's preferences and profile automatically.

FIG. 18 depicts an example of a whiteboard workspace 500 such as in response to activating a to-do global control. In response to activating a to-do global control element, a corresponding to-do list GUI window can be generated to provide one or more lists of actionable items for the current user. The actionable items could be items that have been requested or ordered by the current user or may have been requested or ordered by another user (or triggered automatically in response to execution of a logic flow or other method) to be performed by the current user that is logged into the system.

In the example of FIG. 18, the to-do list window includes two areas displaying high priority and standard priority actions that are to be performed. In this example, the high priority workspace remains empty whereas the standard priority includes a chest x-ray that is to be performed. In this example of the chest x-ray to-do item corresponds to a node that has been associated with an unspecified asthma problem node. Thus, the results of the chest x-ray, when performed can help support making the current diagnosis. The chest x-ray diagnosis, for example, can be specified by the guideline engine in response to the guideline data that has been established for supporting a diagnosis of an unspecified asthma represented by the unspecified asthma node in the workspace 500.

FIGS. 19-22 depict examples of an interactive graphical workspace 600 demonstrating a matrix view of the workspace. As an example, the matrix view may be selected in response to selecting matrix view GUI element associated with a view global control such as shown in FIG. 3A. In the examples of FIGS. 19-22, the interactive work space 600 includes a plurality of columns and rows into which respective graphical nodes are positioned according to relationships specified by relationship data that is stored in memory. For example, each of the rows can correspond to a health problem and different types of data can be categorized into the different respective columns 604, 606, 608, 610 and 612.

As a further example, column 604 can contain medicines, column 606 can contain data of a studies type, column 608 can contain data objects of a procedure type, column 610 can contain another type of data and column 612 can contain data of a test type. Each row thus may correspond to a health problem and supporting evidence data can be placed into each respective data according to the metadata representing its data type. Unassociated health data objects, corresponding to supporting evidence data can be represented in a ribbon bar 614. As disclosed herein, such unassociated data corresponds to orphan data that has not yet been associated with a corresponding health problem such is as provided in column 602.

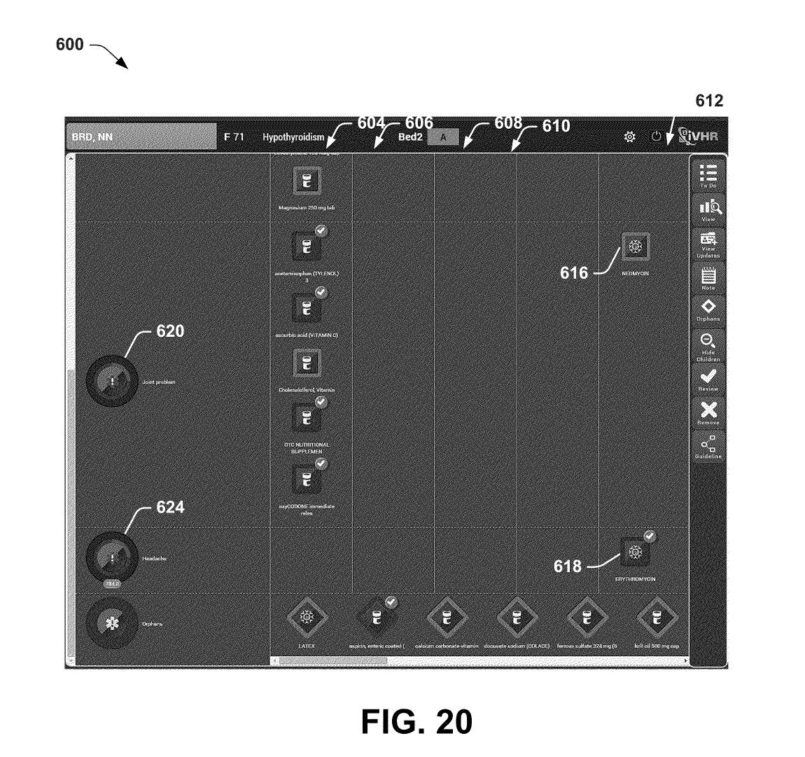

By way of example, an unassociated health data object for neomycin, which resides in GUI area can be selected and dragged into an appropriate column such as demonstrated in FIG. 20 in which the neomycin GUI element 616 is provided in column 612 associated with the joint problem health data object 620. Also demonstrated in FIG. 20 is an erythromycin health data object corresponding to a test data type associated with a headache GUI element 624. The health data object 618 can be moved from the row associated with the headache health data object 624 and into the corresponding row 612 associated with the joint problem health data object 620. Movement from one row to another thus can disassociate the health data object 616 from the object 624 and re-associate it with the other object 620 (e.g., modifying the relationship data accordingly). Similarly, objects can be moved from a corresponding row into which it is associated with a corresponding problem data object into the ribbon (e.g., becoming orphan data). All changes in relationships data can reflected in the relationship data for the current state of the interactive workspace and intermediate changes can be stored in the UI log data, such as disclosed herein.

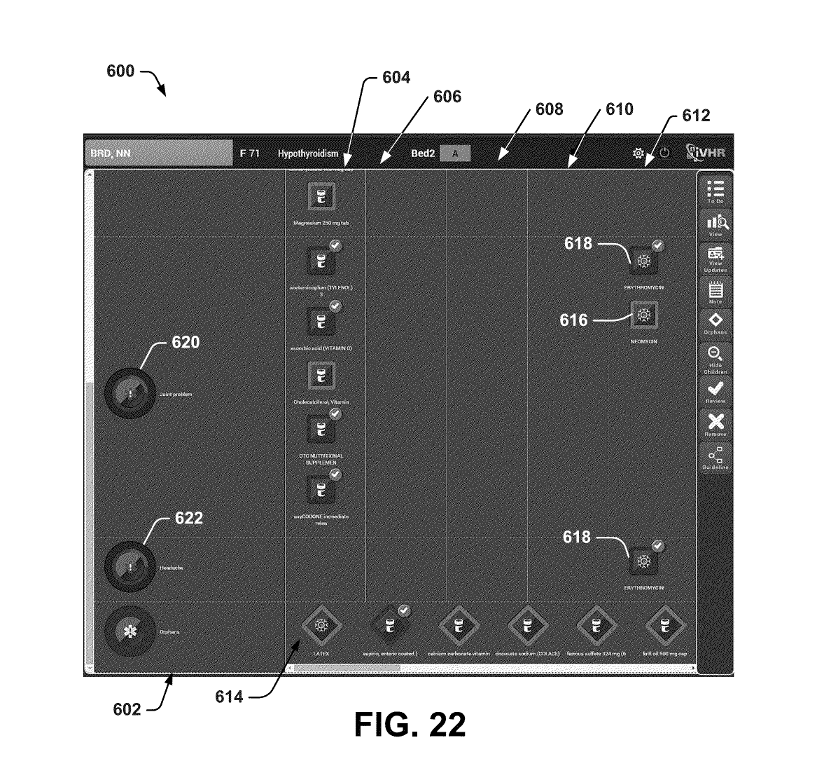

As another example, as shown in FIG. 22, the Erythromycin 618 can be dragged and dropped onto the headache health data object 622 in the health problem column 602 and thereby take on multiple relationships, each of which can be stored as part of the relationship data in memory. Thus in the example of FIG. 22, the Erythromycin health data object 618 as well as any other data object can be associated with multiple health problems. Each such association for a respective health data object can be stored in local memory as part of its relationship data. Additionally as disclosed herein, each of the user interactions with the matrix view of the interactive workspace can be tracked and stored in local memory as documentation data which can be utilized to generate a corresponding documentation report associated with patience care and management. The documentation report further can be provided to the EHR system via a corresponding EHR interface (e.g., via an HL7 message or the like).

While the examples shown herein are demonstrated as two-dimensional, it is appreciated that the concepts are equally applicable to three-dimensional interactive graphical maps and four-dimensional maps (e.g., the fourth dimension being time). For instance, the graphical elements and links can be arranged hierarchically in three-dimensions according to their relative importance in driving a diagnosis for the given patient.

As will be appreciated by those skilled in the art, portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A computer implemented method, comprising:
representing selected health data objects, corresponding to at least one health problem and supporting evidence, as graphical nodes in an interactive workspace, each of the health data objects comprising record data that includes an identifier and status data stored in memory that is separate from an electronic health record (EHR) system to describe at least one condition of the respective health problem or supporting evidence being represented thereby;
representing relationships between the supporting evidence and related health problems in the interactive workspace based on relationship data stored in the memory;
providing graphical user interface controls for implementing each of a plurality different user interactions with respect to the graphical nodes and associated relationships visualized in the interactive workspace; and
modifying the relationship data in the memory in response to a user interaction changing at least one of the relationships between a pair of graphical nodes representing health data objects in the interactive workspace.

2. The method of claim 1, wherein in a first mode of the interactive workspace, the relationships between the supporting evidence and related health problems are represented as connections between related health data objects in the interactive workspace based on the relationship data.

3. The method of claim 2, wherein in a second mode the relationships between the supporting evidence and related health problems are represented by presenting related health data objects in a common spatial area in the interactive workspace based on the relationship data.

4. The method of claim 3, wherein the graphical user interface controls further comprise a view control configured to selectively change the interactive workspace between the first mode and the second mode.

5. The method of claim 1, further comprising storing documentation data in the memory to document and describe each of the user interactions implemented by least one health care provider that result in change in at least one of the supporting evidence and related health problems, the documentation data including identity data of the at least health care provider and an indication of each resulting change according to the relationship data.

6. The method of claim 5, further comprising generating an ordered sequence of text blocks, each of the text blocks describing each change in a respective relationship between the supporting evidence and related health problems for a respective one of the user interactions according to a time in which the changes occurred in response to the user interactions.

7. The method of claim 5, further comprising:
generating review metadata for a given health data object, the review metadata being stored in the documentation data in response to a user input by a given user accessing or causing at least some of the condition data to be visualized in the interactive workspace, and
generating a review indicator associated with the given health data object in the interactive workspace based on the review metadata indicating that the given user has at least one of accessed or caused at least some of the condition data to be visualized in the interactive workspace.

8. The method of claim 1, wherein each health data object includes a data type selected from a group comprising a problem data type, a medicine data type, a procedure data type, a studies type and a clinical data type.

9. The method of claim 1, further comprising:
evaluating each of the health data objects according to preprogrammed guideline data to identify at least one new relationship between a problem health data object and at least one of the supporting evidence health data objects, corresponding metadata being stored in the relationship data to specify the at least one new relationship.

10. The method of claim 9, further comprising:
evaluating a given problem health data object for a patient encounter relative to predetermined guideline data to identify at least one of the supporting health data objects that is stored in the memory and known to have a predetermined relationship with the underlying problem represented by the given problem health data object;
generating an output in the interactive workspace to suggest creating relationship between a given node corresponding to the given problem health data object and at least one other node corresponding to the identified at least one of the supporting health data objects that is known to have the predetermined relationship with the underlying problem.

11. The method of claim 1, further comprising:
generating an other problem health data object for a given patient encounter to define record data that includes associated metadata to describe a proposed diagnosis corresponding to the other problem health data object in response to a user input, generating a new node in the interactive workspace to represent the other problem health data object;
determining whether current the supporting evidence health data objects associated with the given patient encounter is sufficient to support the proposed diagnosis that is represented by the other problem health data object;
in response to determining that the current set of supporting evidence health data objects for the given patient encounter is insufficient to support the proposed diagnosis, generating in the interactive workspace at least one other node corresponding to a new supporting evidence health data object that can support the proposed diagnosis based on comparing the associated metadata with guideline data.

12. The method of claim 11, wherein, in response to determining that the current set of supporting evidence health data objects for the given patient encounter includes at least one supportive health data object that is sufficient to support the proposed diagnosis, modifying the interactive workspace to graphically suggest a supporting relationship between each supportive health data object and the new node based on comparing the associated metadata and the guideline data.

13. The method of claim 12, wherein the graphical suggestion depends on which of a plurality of viewing modes active for the interactive workspace,
wherein in one of the viewing modes for the interactive workspace, the graphical suggestion includes connecting a line between each supportive health data object and the new node, and
wherein in another of the viewing modes for the interactive workspace, the graphical suggestion includes generating a copy of each supportive health data object and spatially aligning the respective copies with the new node.

14. The method of claim 1, further comprising storing metadata in the memory to specify whether a given node, corresponding to a supporting evidence health data object, is related or is not related to at least one other node, graphically representing each of the nodes in the interactive workspace based on the metadata to graphically distinguish nodes that are related to at least one other node from orphan nodes that are not related to at least other node.

15. The method of claim 1, further comprising computing a list of potential diagnoses based on analyzing the guideline data relative to the evidence data objects generated/existing for the given patient encounter, wherein the list of potential diagnoses further specifies additional evidence, if any, needed to support each potential diagnosis in the list.

16. The method of claim 15, wherein the weight function determines the weight for each potential diagnosis based on at least one of an accuracy of the potential diagnosis, a specificity of the potential diagnosis, a role of the user, a level of reimbursement for a potential diagnosis.

17. The method of claim 1, further comprising generating a proposed order data object that specifies at least one recommended order or intervention, corresponding to an interactive graphical node presented in the interactive workspace, which can be converted to an actionable order item in response to a user input accepting the proposed order.

18. The method of claim 1, further comprising:
storing a configuration file that defines executable actions representing a workflow steps to be implemented for a healthcare enterprise, each step including at least one executable action, and
activating a link to the configuration file; and
executing a logic flow of the discrete executable actions in the sequence provided by the configuration file.

19. One or more non-transitory machine-readable media that include code blocks programmed to perform the method of claim 1.

20. A patient white board system comprising:
data representing selected health data objects as graphical nodes and representing relationships between the graphical nodes, corresponding to the selected health data objects as graphical connections between related graphical elements based on relationship data stored in memory for a given patient encounter;
graphical user interface controls to implement interactions with respect to the graphical nodes and links; and
a diagnosis calculator to compute a list of potential diagnoses based on analyzing the guideline data relative to the health data objects for the given patient encounter.

21. The system of claim 20, wherein the list of potential diagnoses further specifies additional evidence, if any, needed to support each potential diagnosis in the list.

22. The system of claim 21, wherein the diagnosis calculator includes a weight function programmed to assign a weight value to each potential diagnosis,
the system further comprising a guideline engine to sort each respective diagnosis in the list of potential diagnoses according to the assigned weight.

23. The system of claim 22, wherein the weight function determines the weight for each potential diagnosis based on at least one of a computed accuracy of the potential diagnosis, a specificity of the potential diagnosis, a role of the user in an associated healthcare enterprise, and a level of reimbursement for a potential diagnosis.

24. The system of claim 23, further comprising a guideline engine programmed to generate a proposed order data object that specifies at least one additional order or intervention, corresponding to an interactive graphical node, which can be converted to an actionable order item in response to a user input to accept the proposed order.

25. The system of claim 24, wherein the guideline engine is further programmed to specify what additional evidence are needed to improve diagnosis accuracy based on proposed data objects.

26. The system of claim 20, further comprising:
an EHR interface to access an EHR system to at least one of retrieve or send health data objects for a given patient;
relationship data stored in memory separate and apart from the EHR system, the relationship data representing a link between health data objects for the given patient; and
a visualization engine to dynamically generate an interactive whiteboard workspace that includes graphical nodes and relationships generated based on patient data, metadata and relationship data.

27. The system of claim 26, further comprising a documentation system programmed to record and store in memory data representing interactions with the workspace.

28. The system of claim 27, wherein the documentation system further comprises a documentation generator programmed to record, as medical decision-making data, user-manipulation of the graphical elements representing health data objects and user-manipulation of the graphical relationships representing links between the selected health data objects to document at least one of patient management and review of clinical data represented by graphical node in the in the interactive whiteboard workspace.

29. The system of claim 20, further comprising:
a compliance function to analyze a diagnosis, corresponding to a diagnosis code, generated for a given patient encounter in response to a user input relative to guideline data to ascertain if the diagnosis is supported by evidence data objects associated with the patient encounter, the compliance function providing requirements data based determining a difference between the evidence data objects associated with the patient encounter and what is stored as the guideline data for the diagnosis code, wherein the compliance function is programmed to specify at least one evidence object needed to support the diagnosis, the evidence object corresponding to at least one of a procedure object, a study object, medication object, and clinical data object.
